(19) United States
(12) Patent Application Publication
(10) Pub. No.: US 2025/0378532 A1
(43) Pub. Date: Dec. 11, 2025

(54) HARDWARE-AWARE NETWORK FOR REAL-WORLD SINGLE IMAGE SUPER-RESOLUTIONS

(71) Applicant: UNIVERSITY OF MASSACHUSETTS, Westborough, MA (US)

(72) Inventors: Rui Ma, Amherst, MA (US); Xian Du, Amherst, MA (US)

(21) Appl. No.: 19/233,646

(22) Filed: Jun. 10, 2025

Related U.S. Application Data
(60) Provisional application No. 63/658,001, filed on Jun. 10, 2024.

(51) Int. Cl. G06T 3/4053; G06T 3/4046

(52) U.S. Cl. CPC G06T 3/4053; G06T 3/4046

(57) ABSTRACT

Various examples are provided related to enhancing resolution of images and more particularly to enhancing the resolution of an image by accounting for the properties, deficiencies, and defects of the imaging system. In one example, a method of enhancing the resolution of an image includes extracting degradation information from a low-resolution image; extracting a shallow feature map from the low-resolution image; combining the degradation information and shallow feature map to form a dense feature map; and creating a super-resolution image from the low-resolution image using the dense feature map. In another example, a method includes extracting a hardware representation of an imaging system; and integrating the hardware representation into a super-resolution network. The Hardware-Aware Super-Resolution method can have significant impact on various areas, such as enhancing the accurate inspection of manufactured products for quality control and enhancing the resolution of medical images to enable more accurate diagnosis and healthcare.

### CROSS REFERENCE TO RELATED APPLICATIONS

This application claims priority to, and the benefit of, U.S. provisional application entitled “Hardware-Aware Network for Real-World Single Image Super-Resolutions” having Ser. No. 63/658,001, filed Jun. 10, 2024, which is hereby incorporated by reference in its entirety.

### STATEMENT REGARDING FEDERALLY SPONSORED RESEARCH OR DEVELOPMENT

This invention was made with government support under Grant Nos. 1942185, 1916866, and 1907250 awarded by the National Science Foundation. The government has certain rights in the invention.

### BACKGROUND

High-resolution digital images are consistently preferred, whether for human satisfaction or for various downstream industrial applications. However, there are instances where obtaining images with the desired resolution is challenging due to limitations in imaging hardware. Factors like low-resolution (LR) cameras or unstable imaging conditions can result in a loss of image resolution. To address this issue, image super-resolution (SR) techniques are frequently employed. These SR techniques are designed to reconstruct high-resolution (HR) images from their LR counterparts. Image SR not only has the potential to enhance image details and realism, but also to overcome the limitations of imaging systems.

### SUMMARY

Aspects of the present disclosure are related to enhancing resolution of images and more particularly to enhancing the resolution of an image by accounting for the properties, deficiencies, and defects of the imaging system used to capture and image. In various aspects, a hardware aware super-resolution (HASR) network comprises two steps. In the first step, the aim is to extract hardware representations. It is hypothesized that, in relatively stable capture environments, images taken by the same camera share similar blur kernels, while those from different cameras exhibit distinct blur kernels. Initially, querying specifications like pixel resolution and sensor type and encoding this information into vectors can be considered. However, for efficient differentiation of images from different hardware setups, contrastive learning can be adopted. This method can group image patches from the same camera and separate patches from different cameras, implicitly embedding the camera's hardware information. In the second step, this hardware information can be integrated into the SR network using the proposed hardware-aware block (HAB), incorporating spatial and channel attention mechanisms.

Furthermore, obtaining real-world LR-HR image pairs can be challenging, resulting in limited large-scale real-world SR datasets. This can be addressed in two ways. First, transfer learning can be applied to the HASR network by initially training the network on publicly available synthetic datasets and fine-tuning it with a small number of real-world datasets. These synthetic datasets simulate degradation processes using isotropic Gaussian filters with additive Gaussian noise. Second, the Real-Micron dataset, containing micron-scale patterns and captured using three Basler CMOS cameras with objectives of various high magnification factors can be introduced.

Contributions can include:
Pioneering the utilization of hardware information to enhance SR generation.
Introducing a novel supervised contrastive learning method for learning unknown degradation processes in various image acquisition systems.
Empirically demonstrating that integrating prior hardware information significantly enhances SR generation.
Presenting a real-world dataset featuring micron-scale patterns and containing precisely aligned HR and LR image pairs with different scale factors.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of an architecture of hardware aware super-resolution (HASR) network, in accordance with various embodiments of the present disclosure.

FIG. 2 illustrates an example of degradation information extraction, in accordance with various embodiments of the present disclosure.

FIG. 3 illustrates an example of an image acquisition system, in accordance with various embodiments of the present disclosure.

FIGS. 4A and 4C are examples of images of a target captured with an acA4112-30 μm camera of the acquisition system of FIG. 3 using (a) a 10× objective and (c) a 20× objective, in accordance with various embodiments of the present disclosure.

FIGS. 4B and 4D are examples of images of a target captured with an acA1300-200 μm camera of the acquisition system of FIG. 3 using (b) a 5× objective and (d) a 10× objective, in accordance with various embodiments of the present disclosure.

FIGS. 5A and 5B are an example of a registered image pair captured with a Basler acA640-750 μm camera using different objectives, 5× and 20×, respectively, in accordance with various embodiments of the present disclosure.

FIGS. 5C and 5D are an example of a registered image pair captured with a Basler acA1300-200 μm camera using different objectives, 5× and 20×, respectively, in accordance with various embodiments of the present disclosure.

FIGS. 6A-6D show examples of visualization of the degradation information from the synthetic dataset DIV2K with different kernel width (σ) before training, SimCLR+SupCon, Supervised, and MoCo-V2+SupCon, respectively, in accordance with various embodiments of the present disclosure.

FIGS. 6E-6H show examples of visualization of the degradation information from real-world datasets for DRealSR dataset, before training; DRealSR dataset, MoCo-V2+SupCon; Real-Micron, before training; and Real-Micron, MoCo-V2+SupCon; respectively, in accordance with various embodiments of the present disclosure.

FIG. 7 illustrates examples of qualitative comparison of the model with other works on ×4 super-resolution on the Real-Micron dataset (top) and ×2 super-resolution on the ImagePair dataset (bottom), in accordance with various embodiments of the present disclosure.

FIG. 8 illustrates a comparison of residual blocks in original EDSR and EDSR with AdaIN fusion, in accordance with various embodiments of the present disclosure.

FIG. 9 illustrates examples of PSNR and SSIM comparison of transfer learning on Real-Micron dataset, in accordance with various embodiments of the present disclosure.

FIGS. 10A and 10B illustrate examples of a CNN based hardware-aware block (HAB) and a transformer based HAB, in accordance with various embodiments of the present disclosure.

FIG. 11 illustrates an example of an image pair registration algorithm, in accordance with various embodiments of the present disclosure.

FIG. 12 illustrates an example of sample images of a US Air Force Hi-Resolution target from the acquisition system, in accordance with various embodiments of the present disclosure.

FIGS. 13-15 illustrate examples of sample images of micro-scale circuits from the acquisition system, in accordance with various embodiments of the present disclosure.

FIG. 16 illustrates an example of a CNN HASR for a Real-Micron dataset, in accordance with various embodiments of the present disclosure.

FIGS. 17A and 17B illustrate examples of fusion methods at different layers for a transformer based HASR where fusion happens after each residual group and a CNN based HASR where fusion happens after each RCAB, respectively, in accordance with various embodiments of the present disclosure.

FIG. 18 illustrates an example of a HASR with a spatial attention (SA) path, in accordance with various embodiments of the present disclosure.

FIG. 19 illustrates an example of a HASR with a channel attention (CA) path, in accordance with various embodiments of the present disclosure.

FIGS. 20-22 illustrate qualitative comparisons of the model with other works on ×4 super-resolutions on the Set14 dataset, the Set5 dataset, and the Urban100 dataset (σ=4.0), respectively, in accordance with various embodiments of the present disclosure.

FIG. 23 is a schematic block diagram illustrating an example of a computing device that can be used for implementation of a HASR network for enhancing resolution of images, in accordance with various embodiments of the present disclosure

### DETAILED DESCRIPTION

Disclosed herein are various examples related to enhancing resolution of images and more particularly to enhancing the resolution of an image by accounting for the properties, deficiencies, and defects of the imaging system used to capture and image. Reference will now be made in detail to the description of the embodiments as illustrated in the drawings, wherein like reference numbers indicate like parts throughout the several views.

Recently, deep learning has paved the way for the development of numerous advanced SR algorithms that leverage large-scale datasets. While these methods excel with artificially degraded LR images, like those created through techniques such as bicubic downsampling, they face challenges when dealing with real-world LR images. This decline in performance results from a domain gap between the training data and the data encountered during inference, particularly when the degradation kernel of real-world LR images differs from the one used for training.

There are typically two approaches to address the SR issue mentioned: (1) generating LR images through multiple degradation models during training, and (2) learning the degradation kernel first and then using it for SR. The first approach struggles with complex real-world degradations, while the second approach is more practical, but it often overlooks a important piece of prior knowledge: the hardware information of image acquisition devices.

Real-world degradations, stemming from factors like camera blur, sensor noise, sharpening artifacts, and image compression, are closely tied to the specific imaging system (camera) in use. Accordingly, there is a need in the art for an improved method of converting or upscaling low-resolution images to higher-resolution.

Therefore, possessing prior knowledge of image acquisition system can significantly enhance real-world SR, a common scenario in industry where known camera models and lenses are typically used to for image acquisition. Leveraging this prior knowledge and the supervised contrastive learning (SupCon) method, hardware representations can be generated and employed to enhance the generation of SR images.

This section is divided into three parts: The first part surveys current solutions for the blind super-resolution (SR) problem, the second part introduces contrastive learning and its variants, and the third part explores feature fusion methods.

### A. Blind SR Methods

There are two categories of blind SR methods. The first category includes methods that incorporate multiple degradation models in the network. For example, it has been proposed to concatenate an LR input image with its degradation map as a unified input to the SR model, allowing for feature adaptation according to the specific degradation and covering multiple degradation types in a single model. A kernel modeling super-resolution network (KMSR) was proposed, where the simulated LR images were generated by applying a specific blur kernel to HR images, which was chosen from a predetermined kernel pool. Other methods built more generic training datasets with more kinds of realistic blur kernels. However, these methods had a significant drawback: they relied on predefined blur kernel pools and could not provide satisfactory results for images with degradations not covered in their pools.

The second category is to estimate the degradation kernel first and then to super resolve the LR images with the learned degradation kernel information. For instance, Iterative kernel correction (IKC) proposed to correct kernel estimation in an iterative way to gradually approach a satisfactory result. “KernelGAN”, an image-specific Internal-GAN that estimated the SR kernel (downscaling kernel) that best preserved the distribution of patches across scales of the LR image, was introduced. However, these methods were time-consuming due to the numerous iterations during inference. Unsupervised contrastive learning was used to estimate the degradation process. Abstract representations was first learned to distinguish the various degradations in the representation space rather than explicitly estimating the exact degradations. A Degradation-Aware SR (DASR) network was then introduced with flexible adaptation to various degradations based on the learned representations. A contrastive loss was used to conduct unsupervised degradation representation learning by contrasting positive pairs against negative pairs in the latent space. However, the degradation representation highly relied on the contents of the LR images because of the assumption that each image had a unique degradation kernel. An unsupervised way to imitate real-world LR images of an unknown downsampling process was proposed. A generative adversarial network was implemented to generate the LR images that had similar distribution to the real-world LR images. Furthermore, to keep the generation process stable, low-frequency loss (LFL) and adaptive data loss (ADL) were utilized to keep the content consistency between the generated LR and the real-world LR images. However, balancing the data loss and the adversarial loss needed to be very careful. Also, the kernel variances were not considered from the training data. The estimated degradation kernel was just an average from all the training data, which would be inaccurate if the training data came from different acquisition systems.

### B. Contrastive Learning

Contrastive learning is a self-supervised learning method widely utilized in computer vision, natural language processing, and other domains. Intuitively, contrastive learning can be considered as learning by comparing. To learn the representations of the samples, contrastive learning compares the similarities among the samples: it aims to embed similar samples (positive examples) close to each other while trying to push different samples (negative examples) away. A simple framework for contrastive learning of visual representations (SimCLR) has been presented. SimCLR learned representations by maximizing agreement between differently augmented views of the same data example via a contrastive loss in the latent space. The paper showed that the methods significantly outperformed previous techniques for self-supervised and semi-supervised learning on ImageNet. However, the batch size for SimCLR training was limited by the hardware constraints such as GPU memory. To address this issue, a dynamic dictionary was introduced with a queue and a moving-averaged encoder, allowing for the creation of a large and consistent dictionary on-the-fly, which facilitated contrastive unsupervised learning. This approach was built upon by incorporating SimCLR's stronger data augmentation and MLP projection head, enabling it to achieve better results than SimCLR on a typical 8-GPU machine. Additionally, if additional labels were provided, they could be integrated into the contrastive framework's similarity and dissimilarity definitions. The self-supervised batch contrastive approach was extended to the fully-supervised setting with two possible versions of the supervised contrastive (SupCon) loss. The SupCon loss offered benefits for robustness to natural corruptions and was more stable to hyperparameter settings such as optimizers and data augmentations.

### C. Feature Fusion

As deep learning continues to evolve in handling multimodal data, the effective fusion of information across multiple modalities is extensively explored. Multimodal information fusion is typically categorized into three main approaches: early (feature-based), late (decision-based), and hybrid fusion. In the context of this disclosure, the focus is on early fusion, where hardware information is treated as a supplementary component rather than an independent modality. Within early fusion, one straightforward technique involves the use of adaptive instance normalization (AdaIN) to align the mean and variance of features from one modality with those from another. Attention mechanisms, widely employed in image super-resolution (SR) networks, have played a pivotal role in early fusion. A channel attention mechanism was proposed to adaptively rescale channel-wise features by considering interdependencies among channels. Additionally, the holistic attention network (HAN) can be introduced to model the comprehensive interdependencies among layers, channels, and positions. An SR network based on graph attention network (SRGAT) fully leveraged internal patch-recurrence within natural images. With the increasing adoption of transformer backbones, self-attention mechanisms are making their way into SR tasks as well. A multiscale hierarchical design, incorporating efficient Transformer blocks, was introduced to capture long-range pixel interactions, even for large images. This approach divides images into multiple patches that interact with each other through self-attention mechanisms within the transformer blocks. This disclosure focuses on investigating whether the fusion of hardware information improves SR performance. Thus, the exploration has been primarily centered on the application of attention mechanisms.

### Method

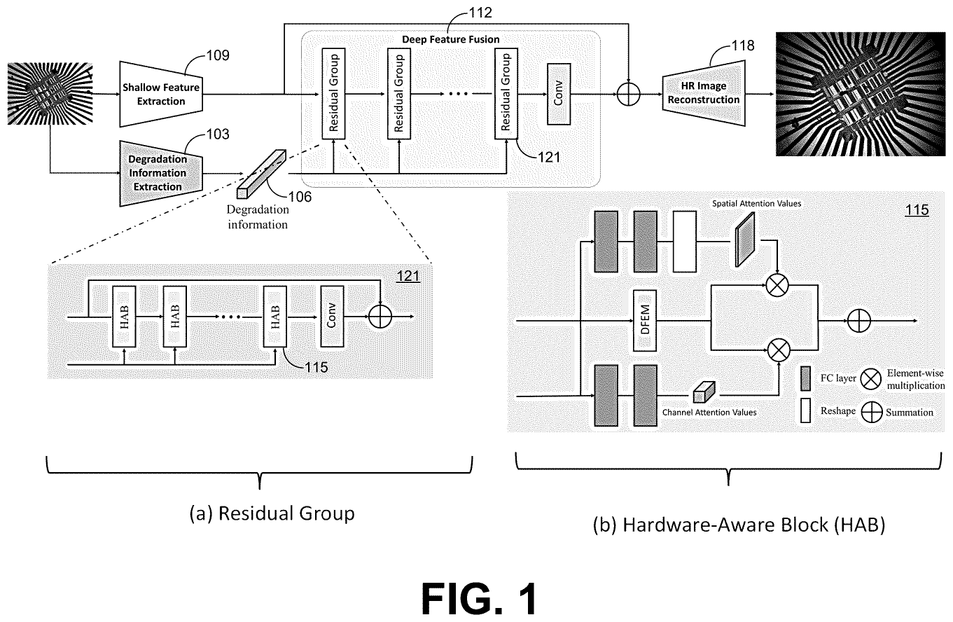

This section begins by elucidating the rationale behind the use of hardware information. It then proceeds to offer a comprehensive overview of the hardware aware super-resolution (HASR) network, as illustrated in FIG. 1.

### A. Motivation of Using Hardware Information

Digital image acquisition systems play a pivotal role in myriad of applications, capturing continuous real-world objects and generating sampled image, denoted by f_{LR}. In these systems, a physical camera can be conceptually modeled as a continuous-space filter, followed by sampling on a lattice. If a higher-resolution camera capable of producing the desired HR image f_{HR} exists, the transformation between the HR image and the LR images can be defined as a function, represented as:

$${f}_{LR} = D ( {f}_{HR} ) , \qquad ( 1 )$$

where D(·) is a degradation function that amalgamates both filtering and down-sampling processes. The essence of SR problem is to derive an estimated HR image \hat{f}_{HR} from f_{LR}, effectively inverting transformation in Error! Reference source not found. Note the SR problem is inherently ill-posed because multiple different HR images can yield the same LR result. To address this, it is transformed into an optimization problem.

Previous SR methods either predefined the degradation function or learned a degradation model for each LR image. However, in real-world scenarios, the degradation function is often more complex than the predefined ones, such as bicubic downsampling with anti-aliasing filter. Additionally, training a degradation prediction model to estimate the degradation function for each LR image heavily relies on the patterns within the LR images. Consequently, the estimation may become inaccurate when applied to LR images with unseen patterns, which can deteriorate the SR results.

Considering that the degradation process originates from the image acquisition system, if we have knowledge that the images in the dataset come from similar image acquisition systems, it logically follows that these images should induce the same degradation process. Furthermore, if we possess a dataset containing information about the image acquisition system for each image, we can harness the contrastive learning method to extract information about these image acquisition systems, inherently representing various degradation processes. The hypothesis posits that incorporating this learned information into the SR generation network will enhance SR performance. This approach eliminates the need for manually defining inaccurate degradation functions. Moreover, this approach defines different types of degradation functions based on the diversity of hardware information, rather than relying solely on individual LR images, aligning it more closely with real-world scenarios. Therefore, the proposed SR algorithm can be represented as:

$${f}_{SR} = HASR ( {f}_{LR} , h ) , \qquad ( 2 )$$

$$h = {F}_{D} ( {f}_{LR} ) , \qquad ( 3 )$$

where h is the feature map representing the degradation information of the current LR image acquisition system, acquired by the Degradation Information Extraction network Fp. Hence, two parts of the loss functions are included in the training process, with its optimization represented by:

$$HASR ( {f}_{LR} ) = {arg min}_{HASR , {F}_{D}} \{ {ℒ}_{1} ( {f}_{SR} , {f}_{HR} ) + {λℒ}_{sup} ( {F}_{D} ( {f}_{LR} ) ) \} , \qquad ( 4 )$$

where [symbol] represents the pixel loss, [symbol] represents the supervised contrastive loss, and λ is a hyperparameter that controls the tradeoff between [symbol] and [symbol] .

### B. Network Architecture

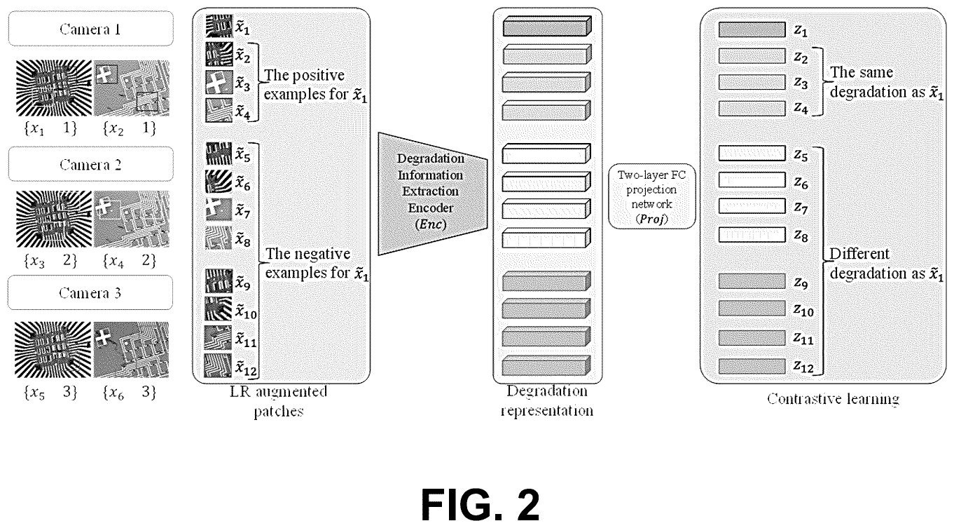

The proposed SR algorithm has two stages: the Degradation Information Extraction stage and the hardware-aware super-resolution (HASR) stage. The first stage aims to extract a discriminative feature map from each LR image, while the second stage is responsible for performing the SR operation. The first stage is facilitated by a pretrained Degradation Information Extraction network, represented as block 103 on the left side of FIG. 1. Within this initial stage, a simple 6-layer convolutional neural network can be used as an encoder and SupCon method can be used to extract the degradation information 106. Then, a Two-layer Fully Connected (FC) projection part can be omitted and the encoded feature map employed as the degradation representation. The complete procedure for Degradation Information Extraction is illustrated in FIG. 2, as will be discussed. As shown in FIG. 1, the degradation representation obtained from the first stage and a LR feature map from the Shallow Feature Extraction block 109 are combined within the Deep Feature Fusion block 112. The fusion operation is primarily executed by the proposed hardware-aware block (HAB) 115. Finally, the super-resolved image is generated through the HR Image Reconstruction block 118, with the guidance of the hardware information. A detailed description of both stages is presented below.

1) Degradation Information Extraction: The goal of the degradation information learning is to extract a discriminative feature map from each LR image. Building on the previous hypothesis, feature maps originating from different acquisition systems will exhibit dissimilarity, whereas those from the similar acquisition system will manifest similarity.

In this context, the degradation information learning was constructed based on the framework of MoCo V2 (“Improved baselines with momentum contrastive learning” by X. Chen, 2020). The presence of a large dictionary containing a diverse set of negative samples plays an important role in contrastive learning, as underscored in existing contrastive learning methods. MoCo V2 offers a spacious and consistent dictionary that decouples the dictionary size from the mini-batch size. This feature enriches the pool of negative samples during training, and the size of the dictionary is not limited by the GPU memory.

Furthermore, positive examples were introduced not only by augmenting the anchor image, but also by augmenting images taken from the same acquisition system. Consequently, the LR image datasets in the model are distinctively labeled with corresponding acquisition systems. The SupCon loss function used is as follows:

$${L}_{sup} = {\sum }_{i ∈ I} {L}_{sup , i} = {\sum }_{i ∈ I} \frac{- 1}{\vert P ( i ) \vert} {\sum }_{p ∈ P ( i )} log \frac{exp ( {z}_{i} \cdot {z}_{p} / τ )}{{\sum }_{a ∈ A ( i )} exp ( {z}_{i} \cdot {z}_{a} / τ )} . \qquad ( 5 )$$

In this equation, i∈I={1 . . . 2N} represents the index of an arbitrary augmented sample, zᵢ=Proj(Enc(\tilde{x}ᵢ)) represents the feature map generated by the Degradation Information Extraction Encoder and the projection network, the · symbol denotes the inner product, τ∈ [symbol] is a scalar temperature parameter, A(i)=I\{i} represents all the indices except i, P(i)={p∈A(i):\tilde{y}ₚ=\tilde{y}ᵢ} represents all the indices that have the same label as the ith augmented sample, and |P(i)| is its cardinality.

FIG. 2 serves as an illustration of (5). At the beginning of each training batch, a set of N randomly sampled {image, acquisition system label} pairs {xₙ,yₙ}_{n=1 . . . N}, are selected. The corresponding training data comprises 2N pairs, {\tilde{x}ᵢ,\tilde{y}ᵢ}_{i=1 . . . 2N}, where \tilde{x}₂ₙ and \tilde{x}₂ₙ₋₁ represent two random augmentations or “views” of xₙ (n=1 . . . N), and \tilde{y}₂ₙ₋₁=\tilde{y}₂ₙ=yₙ. FIG. 2 presents an example with N=6, i=1, P(1)={2,3,4}, A(1)={2,3, . . . ,12}, and the labels for the three acquisition systems (different cameras in FIG. 2) are respectively {1,2,3}. Intuitively, for the ith augmented sample, all the other augmented samples with the same label are expected to be positive samples, while the remaining augmented samples are expected to be negative samples. This equation is simply an extension of the classical self-supervised contrastive loss that enables multiple positive examples in a batch of training data.

When the training is completed, like classical contrastive learning methods, the degradation representation hᵢ is used for the SR algorithm in this paper.

Discussion. The proposed degradation information learning does not require the ground-truth degradation process. Its goal is to learn the hidden distinctive characteristics of degraded images taken from the different acquisition systems for distinguishing. Such a good degradation representation can improve the SR network performance, described further below.

2) HASR network: Given the degradation information extracted from LR images we can integrate this information into an SR network backbone through deep feature fusion. As shown in FIG. 1, the proposed HASR network mainly contains three components: shallow feature extraction, deep feature fusion, and the HR image reconstruction.

A convolution layer is first utilized to extract the shallow feature map F₀ from f_{LR}, which can be represented by:

$${F}_{0} = {W}_{3}^{( 3 , mid )} ( {f}_{LR} ) , \qquad ( 6 )$$

where

$${W}_{3}^{( 3 , mid )}$$

denotes a convolution layer with filter size 3×3, input channel 3, and output channel mid. mid is a hyper parameter that decides the number of filters of the shallow feature extraction convolution layers. Next, the feature map F₀ and the degradation representation h will go through multiple blocks of the residual group for the deep feature fusion 112 (FIG. 1). Each residual group 121 takes both the feature map from the previous residual group and the degradation representation h as inputs, and outputs the fused feature map Fᵢ,

$${F}_{i} = {H}_{ResG}^{i} ( {F}_{i - 1} , h ) , \qquad ( 7 )$$

where

$${H}_{ResG}^{i}$$

represents the ith residual group. More details of the residual group will be presented later. Then, after the last residual group, the fused feature map Fₗₐₛₜ will go through a convolution layer and make the summation with F₀ (see (6)) to create the dense feature map F_{DF} by the global residual learning:

$${F}_{DF} = {W}_{3}^{( mid , mid )} ( {F}_{last} ) + {F}_{0} . \qquad ( 8 )$$

Finally, the dense feature map F_{DF} will go through the HR reconstruction decoder. To effectively upscale the dense feature map F_{DF}, the decoder utilizes efficient sub-pixel CNN (ESPCNN) followed by a single convolution layer to output the three-channel SR images:

$${f}_{SR} = {W}_{3}^{( mid , 3 )} ( {H}_{ESPCN} ( {F}_{DF} ) ) , \qquad ( 9 )$$

$${H}_{ESPCN} = \{ \begin{matrix}PS ( {W}_{3}^{( mid , 4 * mid )} ( \cdot ) ) & if upscale = 2 , \\ PS ( {W}_{3}^{( mid , 4 * mid )} ( PS ( {W}_{3}^{( mid , 4 * mid )} ( \cdot ) ) ) ) & if upscale = 4 ,\end{matrix} \qquad ( 10 )$$

where PS represents the pixel-shuffle operation with the scale factor of 2.

Residual Group: The Residual Group 121 serves as an important component in deep feature fusion 112. The incorporation of multi-level skip connections allows abundant low-frequency information to be bypassed, enabling the main network to focus on learning high-frequency information. As shown in illustration (a) of FIG. 1, each residual group 121 comprises multiple HABs 115. The current residual group i takes the previous fused feature map Fᵢ₋₁ from the previous residual group and the degradation information h as inputs. Then, Fᵢ₋₁ and h go through d HABs. Finally, the residual group outputs the fused feature map Fᵢ with the long skip connection. It can be formulated as:

$${F}_{i} = {H}_{HAB}^{d} ( ( … {H}_{HAB}^{1} ( {F}_{i - 1} , h ) … ) , h ) + {F}_{i - 1} , \qquad ( 11 )$$

where

$${H}_{HAB}^{d}$$

represents the dth HAB. d is a hyper parameter that determines the number of HABs 115 in each residual group 121.

Hardware-Aware Block: The detailed structure of the HAB is illustrated in illustration (b) of FIG. 1. The current HAB j takes the fused feature map from previous HAB and the degradation information h as inputs. It involves a deep feature extraction module (DFEM) and a dual-path attention mechanism. The DFEM can be either CNN-based or transformer-based feature extraction layers. More details of the structure with DFEM will be discussed below. The dual-path attention mechanism involves both channel attention (CA) and spatial attention (SA) paths. The output of the current HAB, H_{HAB}^{j} can be inferred by:

$${F}_{i}^{j} = DFEM ( {F}_{i}^{j - 1} ) ⊗ Rs ( L ( h ) ) + DFEM ( {F}_{i}^{j - 1} ) ⊗ L ( h ) , \qquad ( 12 )$$

where

$${F}_{i}^{j}$$

represents the output feature map of the jth HAB of the ith residual group. j∈{1 . . . d},

$${F}_{i}^{0} = {F}_{i} \cdot L$$

represents the two-layer multilayer perceptron (MLP), Rs represents the reshape operation, ⊗ represents the element-wise multiplication. If the feature map

$${F}_{i}^{j - 1}$$

has the dimension of [symbol] , the degradation information will travel through dual paths before implementing element-wise multiplication with the feature map. The first path contains two fully connected (FC) layers and a reshape operation that projects the dimension of the degradation information to [symbol] as the spatial attention values. The second path contains two FC layers that project the dimension of the degradation information [symbol] as the channel attention values. During element-wise multiplication, the attention values are broadcasted accordingly: spatial attention values are broadcasted (copied) along the channel dimension, and vice versa. This parallel attention mechanism enables the network to extract more informative features from the degradation information.

Discussion Current SR networks designed to handle multiple degradations often combine degradation information with image feature maps and directly input them into the SR network. However, this direct integration using convolution may introduce interference due to the inherent domain gap between degradation information and image features. In this approach, degradation information can be utilized as attention values within dual paths, allowing it to effectively harness this information to adapt to specific degradation scenarios. The spatial attention path focuses on optimizing the connections between adjacent pixels in the image, guided by the degradation information. Meanwhile, the channel attention path is dedicated to optimizing the relationships between feature channels, again guided by degradation information. Subsequently, by optimizing through these two attention paths, their results can be combined to achieve the fusion of degradation information and deep feature maps. An ablation study on the fusion method to empirically demonstrating its effectiveness is described.

### Experiments

In this section, the super-resolution dataset named Real-Micron created from the real-world micron-scale patterns is introduced. The experiment details and results based on open-source synthetic datasets, real-world datasets including DRealSR, ImagePairs, and Real-Micron dataset are then presented. An ablation study is presented at the end.

### A. Real-Micron Datasets

Sets of LR and HR images were collected at multiple resolutions with a combination of three Basler cameras and three Mitutoyo objectives to build a dataset for learning and evaluating the super-resolution models of the real-world micron-scale patterns.

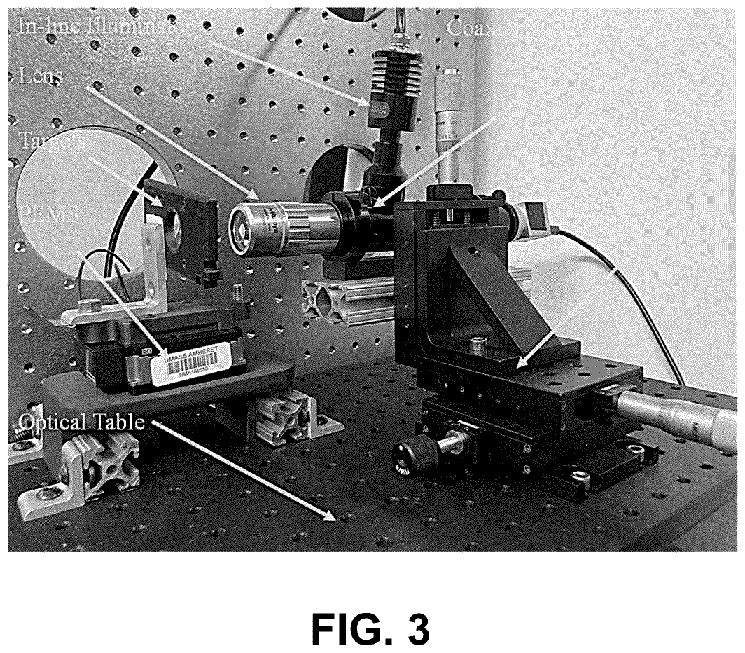

1) Setup of Image Acquisition: The image acquisition system was mounted on an optical table to keep it as stable as possible, as shown in FIG. 3. An auto-focus algorithm was applied during the acquisition process. The cameras and objectives could be easily unscrewed from the coaxial in-line assembly unit. The working distance could be adjusted by the translation stages and fine-tuned by the piezoelectric motion stage (PEMS).

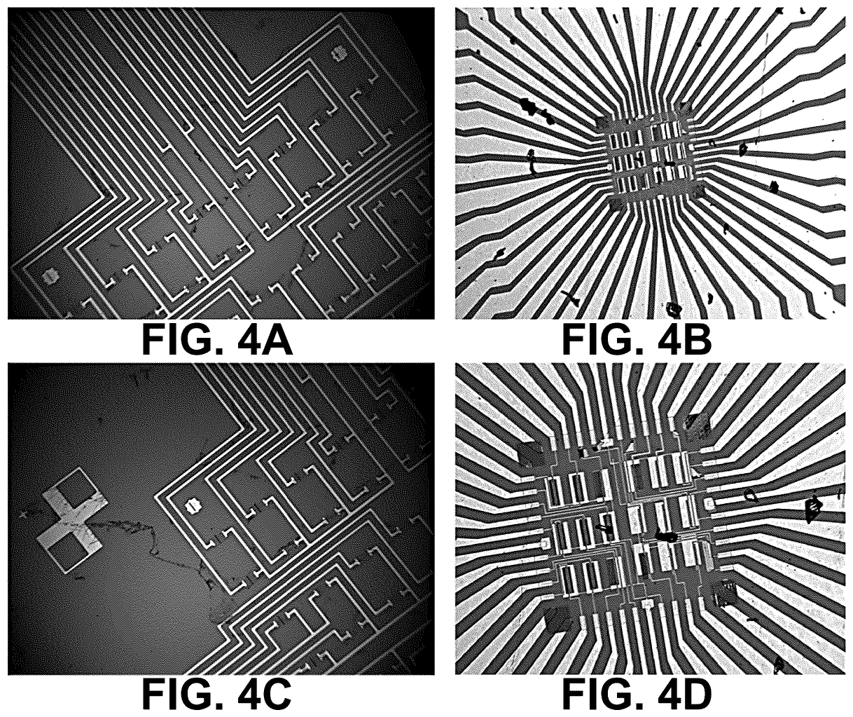

Four different samples were captured by the acquisition system, including the US Air Force Hi-Resolution target and three different micro-scale circuits as shown in FIGS. 4A-4D. Different parts of each sample were captured by three different cameras. For each camera, images with three different resolutions were captured using the objectives with 20, 10, and 5 magnifications (20×, 10×, and 5×). After image pair registration, the images captured by 20×, 10× and 5× objectives were respectively ground-truth (GT), two times downsampled LR images (LR-×2), and four times downsampled LR images (LR-×4) as the super-resolution dataset. Furthermore, each LR image was labeled by the camera number, showing which camera it came from.

To reduce sensor noise, L(L=10) consecutive images were captured for each scene. Therefore, the raw images are computed by:

$${X}_{raw} = \frac{1}{L} {\sum }_{l = 1}^{L} {X}_{l} , \qquad ( 13 )$$

where Xₗ represents the Ith consecutive image. Each of the L consecutive images was captured under constant illumination and without interframe motion.

2) Image Pair Registration: To create the pixel-wise aligned image pairs in different resolutions, an image pair registration algorithm was utilized. For the images acquired by each model of the camera, image registration algorithms were implemented between the 5× and 10× objectives, the 10× and 20× objectives as the two times downsampling pixel-wise aligned pairs, and the 5× and 20× objectives as the four times downsampling pixel-wise aligned pairs. However, obtaining pixel-wise aligned image pairs is not straightforward due to duplicate patterns and unstable luminance conditions in the circuit targets. As shown in FIGS. 4A-4D, conventional image registration algorithms such as SIFT, SURF, and SuperGlue cannot produce accurate results. To obtain accurate image pair registration of our dataset, a coarse-to-fine registration algorithm was designed that maximizes the structural similarity index measure (SSIM) between the transformed LR image and the HR image.

Denote I_{HR} and I_{LR} as the HR and the LR images to be registered. The final target of our algorithm is to maximize the objective function:

$${max}_{TransM} SSIM [ Crop ( TransM \cdot {I}_{LR} ) , {I}_{HR} ] , \qquad ( 14 )$$

where TransM is the affine transformation matrix, Crop is the cropping operation to make the transformed I_{LR} the same size as I_{HR}, ∥·∥_{SSIM} is the structural similarity index measure (SSIM).

To find the accurate TransM, point correspondences between I_{HR} and I_{LR} must be also accurate. First, the registration algorithm can be implemented to obtain the point correspondences since it solved the problem of duplicate and deformable patterns. Then, given the scale factor from the magnification of the lenses, other unknown parameters in TransM can be calculated from the point correspondences using the least square method. Next, several cropped candidates can be proposed based on the inverse transformation of I_{HR}. Due to the stability of the acquisition system, scale and translation are the principal transformations. Therefore, identifying four corners of I_{HR}. inverse(TransM) will be enough for proposing the candidates. Last, the SSIM values can be calculated to pick the best candidate. The detailed registration algorithm is described below.

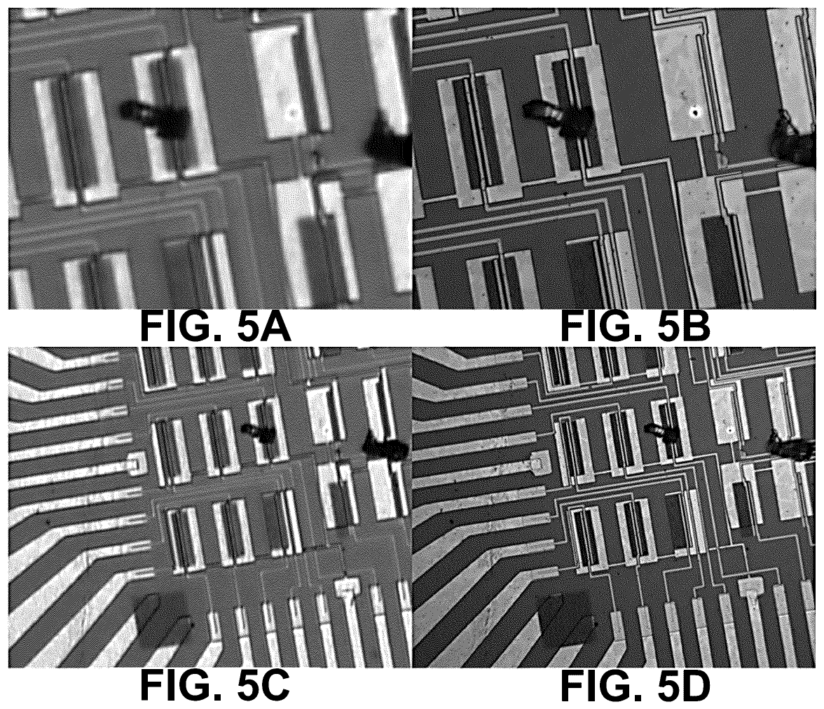

FIGS. 5A-5D show examples of the registered image pairs from different cameras, and conspicuous field of view (FOV) differences can be observed between the two cameras. The quantitative results are presented to prove that the images taken from different cameras have different degradation processes. Note: it is difficult to observe the degradation differences among cameras by eyes.

### B. Experimental Setup

To train the Degradation Information Extraction network, LR images were first synthesized according to (1). The simulation of the degradation process included Gaussian blurring and bicubic downsampling.

To evaluate the performance of the degradation information, five different isotropic Gaussian kernels were implemented with bicubic downsampling on the HR images in the synthetic experiment. Five different image acquisition systems were simulated by the five 2D-Gaussian blurring kernels with σ² setting to [0.5, 1.0, 2.0, 3.0, 4.0], respectively. The size of the Gaussian kernels was fixed to 21×21. LARS optimizer was also used to train the degradation information network with the SupCon loss with 128 batch size and 2 augmented views (see (5)). During training, each of the 128 LR image patches was randomly selected from different degradation processes and cropped into size 160×160. Data augmentation was then performed through random flipping and transposing. The start learning rate was 0.4, and we performed 1000 iterations of training. The training images of the DIV2K dataset were separated into 70%, 10%, and 20% as the training set, validation set and one of the test sets, respectively. Flickr2K, BSD100, Set5, Set14, and Urban100 were also included as the test sets.

The same training process was employed for the real-world datasets (DRealSR, ImagePairs, and Real-Micron) as for synthetic datasets, with the difference being that we already had real LR images and different camera labels in real-world datasets.

The HASR model was evaluated using both the synthesized LR-HR image pairs with known blurring kernels and downsampling methods and the real-world LR-HR image pairs with unknown degradation processes.

For synthetic experiments, training images from the DIV2K and Flickr2K datasets were used as the training set and the Set5, Set14, and Urban100 benchmark datasets as the testing set. HR images were degraded into LR images using the same methods as used to train the Degradation Information Extraction network. The HASR network was trained with a combination of SupCon loss and L1 loss for 200K iterations, with the learning rate of 1×10⁻⁴ for the SR part, 1×10⁻⁹ for the degradation information part, and decaying half every 40K iterations. The hyperparameter λ was set to 0.1, and the Adam optimizer was used with β₁=0.9, β₂=0.999 for optimization.

The registered image pairs from DRealSR, ImagePairs, and Real-Micron datasets were used to conduct real-world experiments. DRealSR consisted of real-world LR and HR images collected by zooming DSLR cameras. The dataset included five DSLR cameras (Canon, Nikon, Olympus, Panasonic, and Sony), corresponding to five different acquisition systems of the Degradation Information Extraction network. ImagePairs used a beam-splitter to capture the same scene by a low resolution camera (LRC) and a high resolution camera (HRC). The LRC can be the sixth acquisition system for the Degradation Information Extraction network. For the ×2 experiments, the DRealSR and ImagePairs were combined for training and testing. For the ×4 experiments, we only used DRealSR for training and testing since ImagePairs does not have the ground-truth HR images. However, the Real-Micron dataset does not have enough training samples. Therefore, transfer learning was implemented to improve the model performance. The Real-Micron dataset was first separated into 80% and 20% as the training and testing datasets, respectively. Next, the best model trained on the Real-Micron dataset for extracting the hardware information (MoCo-V2+SuperCon) was selected to initialize the Degradation Information Extraction part of HASR network. Then, the other part of HASR network was initialized by the model trained on the synthetic experiments (DIV2K and Flickr2K datasets). Finally, the HASR network was trained on the Real-Micron dataset for 20K iterations by freezing the Degradation Information Extraction part and partially freezing the residual groups. Specifically, the generality versus specificity of neurons in each residual group of the network was experimentally quantified by freezing the trainable parameters of different residual groups during the fine-tuning.

Experiments were conducted using PyTorch and MMediting. NVIDIA RTX3090 and RTX2080ti GPUs were used for training and testing.

### C. Experiments on the Degradation Information Extraction Network

To evaluate the performance of the degradation information, the supervised contrastive methods were compared to unsupervised contrastive methods, including SimCLR and MoCo V2, and the supervised method. To be fair, the same backbones ResNet-18 and 6-layer CNNs were used to compare different methods. For the performance evaluation, a classification head (a supervised linear classifier: two fully connected layers followed by SoftMax) was added to the backbone and the pretrained weights loaded into the backbone. The weights of the backbone were then frozen and the whole network trained for a small number of epochs.

TABLE III presents a comparison of the classification performance using different methods for the isotropic Gaussian kernels. The results demonstrate that the supervised contrastive and the classic supervised methods outperform the unsupervised methods in this classification task due to their use of label information. Supervised contrastive learning can improve classifier accuracy and robustness. This method was therefore selected to extract degradation information, as supported by the results in TABLE I. Surprisingly, simple 6-layer CNNs outperform ResNet-18 in all the three methods because they can effectively represent degradation information, unlike the more complex ResNet-18, which has too many redundant trainable parameters. Additionally, limited training data and iterations can cause overfitting issues with ResNet-18.

TABLE I
Cameras and Lenses Used in Data Collection.

| Cameras | Lenses |
|---|---|
| Basler acA640 - 750 μm | 5× |
| Basler acA1300 - 200 μm | 10× |
| Basler acA4112 - 30 μm | 20× |

Note:
All lenses are Mitutoyo Plan Apo Infinity Corrected Long WD Objective

TABLE II
The classification results for real-world datasets.

| Method (backbone) | DRealSR | Real-Micron |
|---|---|---|
| Supervised (6-layer CNNs) | 98.9% | 85.9% |
| SimCLR + SupCon (6-layer CNNs) | 95.7% | 84.4% |
| MoCo-V2 + SupCon (6-layer CNNs) | 100% | 93.8% |

TABLE III
The results of 5-class classification for isotropic Gaussian kernels.

| Method (backbone) | DIV2K | Flickr2K | BSD100 | Set5 | Set14 | Urban100 |
|---|---|---|---|---|---|---|
| MoCo-V2 (ResNet-18) | 71.8% | 76.4% | 68% | 56% | 65.7% | 72.8% |
| Supervised (ResNet-18) | 89.4% | 85.6% | 90.4% | 76% | 85.7% | 83.4% |
| Supervised (6-layer CNNs) | 95.9% | 96.1% | 92.6% | 84.0% | 91.4% | 93.2% |
| SimCLR + SupCon (ResNet-18) | 87.9% | 86.6% | 87.2% | 72.0% | 78.6% | 82.2% |
| SimCLR + SupCon (6-layer CNNs) | 94.3% | 95.6% | 93.8% | 88.0% | 95.7% | 93.8% |
| MoCo-V2 + SupCon (ResNet-18) | 89.2% | 91.1% | 88.0% | 72% | 84.3% | 84.8% |
| MoCo-V2 + SupCon (6-layer | 96.1% | 95.5% | 94.6% | 88.0% | 95.7% | 94.8% |
| CNNs) | | | | | | |

Given the 6-layer CNNs perform well in synthetic experiments, we opt to use them to train the real-world datasets. TABLE II presents the classification results of these real-world datasets. The supervised contrastive method with MoCo-V2 structure achieves the best classification accuracy on average. The Degradation Information Extraction network was therefore finalized with 6-layer CNNs as the backbone, MoCo-V2 as the training algorithm, SuperCon loss as the loss function.

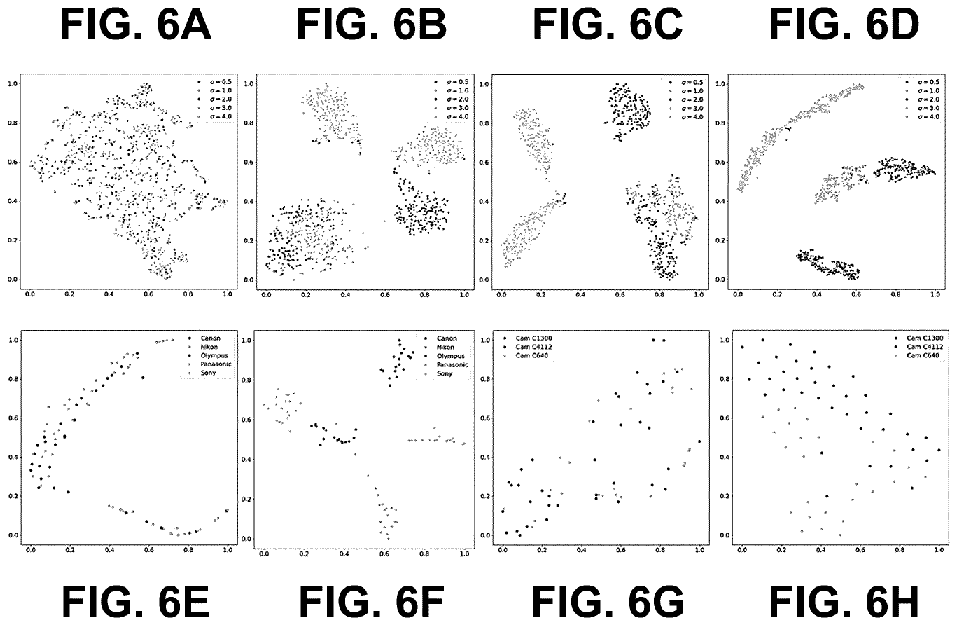

To further visualize the learned degradation information, we used the T-SNE method to cluster LR images from both synthetic and real-world datasets. The degradation representations of those LR images were fed to the Degradation Information Extraction networks and then visualized. FIGS. 6A-6H show the visualization results, where FIGS. 6A-6D in the first row includes the results of the synthetic dataset DIV2K with five different isotropic Gaussian blurring kernels and FIGS. 6D-6H om the second row includes the results of the DRealSR dataset with five DSLR cameras and the results of Real-Micron dataset with three different Basler cameras. The visualization results reveal the feature vectors are well clustered by different degradation kernels or different cameras. MoCo-V2 can distinguish different categories better than other algorithms, as demonstrated in TABLE III and TABLE II. FIG. 6H is less distinguishable because the three Basler cameras have very similar specifications, making their degradation information quite similar.

### D. Experiments on the HASR Network

Simulation experiments were conducted on LR-HR pairs with known blurring kernels and downsampling methods, i.e., isotropic Gaussian blurring kernels with bicubic downsampling method. We compared our CNN based HASR to several recent CNN based SR algorithms, including RDN, Real-ESRGAN and DASR, using their pretrained models. Furthermore, the adoption of stronger Transformer backbones has gained significant traction recently. To validate that the proposed degradation information's impact on enhancing SR is not confined to the SR generation network's backbone, experiments were conducted using Transformer based backbones as well, including DiffBIR, HAT, SwinIR with their pretrained models, fine-tuned Restormer, and Swin-Transformer based HASR. TABLE IV shows the PSNR and SSIM comparison results among the CNN based backbones, indicating that with the assistance of the degradation information, our CNN based HASR algorithm outperforms other algorithms, especially when the LR images are heavily blurred by a greater σ value. TABLE V presents a comparison of PSNR and SSIM results among the Transformer based backbones. Similar to TABLE V, it was found that the inclusion of degradation information consistently enhances the quality of SR results. Taking advantage of both local self-attention mechanism and the shifted window scheme, the Swin-Transformer based HASR achieves the best performance across most test datasets.

Experiments were also conducted on real-world LR-HR image pairs using DRealSR and ImagePairs datasets for the ×2 experiments and DRealSR dataset for the ×4 experimens. We then used Real-Micron dataset for another real-world dataset evaluation. As shown in TABLE VI, our HASR algorithm consistently achieves higher PSNR and SSIM values compared to most other algorithms. It's worth noting that CDC exhibits higher SSIM values in certain cases, as it dissects an image into three components (flat, edges, and corners) and reconstructs each component individually. In contrast, our proposed method is designed to reconstruct the entire image as a whole. However, an interesting avenue for future research could involve adapting CDC to incorporate degradation information.

TABLE IV
PSNR and SSIM comparison of CNN based models on open-source synthetic datasets.

| | | Kernel width (σ) | | | | | | | | | | | |
|---|---|---|---|---|---|---|---|---|---|---|---|---|---|
| | | 1.0 | 2.0 | 3.0 | 4.0 | 1.0 | 2.0 | 3.0 | 4.0 | 1.0 | 2.0 | 3.0 | 4.0 |
| Method | scale | Set5 (PSNR/SSIM) | | | | Set14 (PSNR/SSIM) | | | | Urban100 (PSNR/SSIM) | | | |
| RDN | ×2 | 30.63 | 26.13 | 23.90 | 22.56 | 27.74 | 24.21 | 22.53 | 21.52 | 24.58 | 21.05 | 19.56 | 18.71 |
| | | 0.878 | 0.748 | 0.659 | 0.602 | 0.808 | 0.653 | 0.565 | 0.515 | 0.803 | 0.600 | 0.491 | 0.434 |
| Real- | | 27.94 | 27.03 | 25.78 | 24.78 | 26.00 | 25.31 | 24.24 | 23.21 | 23.08 | 22.24 | 20.97 | 19.99 |
| ESRGAN | | 0.839 | 0.812 | 0.770 | 0.731 | 0.747 | 0.711 | 0.656 | 0.609 | 0.751 | 0.705 | 0.633 | 0.571 |
| DASR | | 35.17 | 32.64 | 25.30 | 23.19 | 30.66 | 28.64 | 23.38 | 21.81 | 28.95 | 26.32 | 20.46 | 19.09 |
| | | 0.934 | 0.902 | 0.732 | 0.640 | 0.875 | 0.820 | 0.624 | 0.544 | 0.908 | 0.840 | 0.553 | 0.454 |
| CNN | | 35.27 | 32.89 | 30.48 | 28.89 | 30.98 | 29.12 | 27.14 | 25.95 | 28.60 | 26.46 | 24.00 | 22.89 |
| HASR | | 0.928 | 0.896 | 0.850 | 0.811 | 0.874 | 0.824 | 0.749 | 0.698 | 0.900 | 0.845 | 0.749 | 0.691 |
| (MoCo) | | | | | | | | | | | | | |
| CNN | | 35.40 | 32.95 | 30.57 | 28.95 | 31.19 | 29.34 | 27.22 | 25.75 | 28.80 | 26.72 | 24.21 | 22.99 |
| HASR | | 0.932 | 0.896 | 0.851 | 0.813 | 0.880 | 0.827 | 0.751 | 0.685 | 0.905 | 0.852 | 0.759 | 0.697 |
| (SimCLR) | | | | | | | | | | | | | |
| RDN | ×4 | 29.10 | 25.96 | 23.86 | 22.54 | 26.22 | 24.02 | 22.50 | 21.50 | 23.75 | 21.42 | 20.09 | 19.25 |
| | | 0.824 | 0.736 | 0.656 | 0.601 | 0.716 | 0.634 | 0.562 | 0.514 | 0.733 | 0.616 | 0.535 | 0.487 |
| Real- | | 26.16 | 25.63 | 24.56 | 23.33 | 24.37 | 24.13 | 23.18 | 22.06 | 21.77 | 21.26 | 20.23 | 19.14 |
| ESRGAN | | 0.721 | 0.704 | 0.668 | 0.616 | 0.665 | 0.648 | 0.604 | 0.550 | 0.677 | 0.654 | 0.600 | 0.530 |
| DASR | | 29.98 | 29.91 | 29.28 | 28.05 | 26.34 | 26.29 | 25.87 | 25.03 | 24.21 | 24.06 | 23.61 | 22.81 |
| | | 0.859 | 0.856 | 0.840 | 0.804 | 0.736 | 0.731 | 0.709 | 0.670 | 0.750 | 0.742 | 0.719 | 0.676 |
| CNN | | 30.66 | 30.05 | 29.83 | 29.73 | 26.99 | 26.55 | 26.25 | 25.45 | 25.36 | 24.95 | 24.33 | 23.64 |
| HASR | | 0.847 | 0.826 | 0.819 | 0.803 | 0.749 | 0.726 | 0.706 | 0.653 | 0.735 | 0.709 | 0.704 | 0.657 |
| (MoCo) | | | | | | | | | | | | | |
| CNN | | 29.96 | 30.03 | 29.35 | 27.97 | 26.58 | 26.53 | 26.08 | 25.18 | 23.98 | 23.86 | 23.46 | 22.61 |
| HASR | | 0.842 | 0.842 | 0.824 | 0.791 | 0.727 | 0.723 | 0.700 | 0.660 | 0.739 | 0.735 | 0.711 | 0.666 |
| (SimCLR) | | | | | | | | | | | | | |

TABLE V
PSNR and SSIM comparison of Transformer based models on open-source synthetic datasets.

| | | Kernel width (σ) | | | | | | | | | | | |
|---|---|---|---|---|---|---|---|---|---|---|---|---|---|
| | | 1.0 | 2.0 | 3.0 | 4.0 | 1.0 | 2.0 | 3.0 | 4.0 | 1.0 | 2.0 | 3.0 | 4.0 |
| Method | scale | Set5 (PSNR/SSIM) | | | | Set14 (PSNR/SSIM) | | | | Urban100 (PSNR/SSIM) | | | |
| DiffBIR | ×2 | 27.24 | 26.24 | 25.54 | 24.14 | 23.98 | 23.60 | 23.02 | 22.18 | 22.28 | 21.76 | 20.76 | 19.70 |
| | | 0.785 | 0.756 | 0.736 | 0.681 | 0.632 | 0.624 | 0.583 | 0..544 | 0.685 | 0.654 | 0.585 | 0.508 |
| HAT | | 30.64 | 26.14 | 23.91 | 22.57 | 27.81 | 24.22 | 22.54 | 21.52 | 24.66 | 21.05 | 19.56 | 18.72 |
| | | 0.891 | 0.767 | 0.675 | 0.613 | 0.817 | 0.660 | 0.572 | 0.522 | 0.808 | 0.599 | 0.487 | 0.429 |
| Restormer | | 31.45 | 29.57 | 27.50 | 25.84 | 28.75 | 26.87 | 24.88 | 23.57 | 25.45 | 23.49 | 21.66 | 20.56 |
| | | 0.891 | 0.843 | 0.777 | 0.717 | 0.838 | 0.766 | 0.672 | 0.608 | 0.825 | 0.735 | 0.620 | 0.544 |
| SwinIR | | 32.31 | 27.71 | 26.95 | 23.53 | 29.41 | 25.81 | 24.81 | 23.66 | 26.26 | 22.27 | 21.11 | 19.96 |
| | | 0.916 | 0.812 | 0.704 | 0.699 | 0.825 | 0.656 | 0.593 | 0.540 | 0.810 | 0.589 | 0.483 | 0.420 |
| Swin- | | 37.34 | 34.29 | 31.70 | 30.55 | 31.23 | 30.39 | 28.74 | 26.03 | 28.55 | 26.45 | 24.46 | 22.89 |
| Transformer | | 0.924 | 0.901 | 0.861 | 0.828 | 0.872 | 0.823 | 0.758 | 0.658 | 0.882 | 0.821 | 0.715 | 0.621 |
| HASR | | | | | | | | | | | | | |
| (MoCo) | | | | | | | | | | | | | |
| DiffBIR | ×4 | 24.55 | 24.66 | 23.84 | 22.32 | 22.53 | 22.30 | 21.78 | 21.43 | 20.67 | 20.54 | 20.24 | 19.76 |
| | | 0.703 | 0.703 | 0.672 | 0.611 | 0.566 | 0.543 | 0..514 | 0.495 | 0.587 | 0.573 | 0.549 | 0.521 |
| HAT | | 29.36 | 25.98 | 23.87 | 22.54 | 26.39 | 24.05 | 22.51 | 21.51 | 24.18 | 21.47 | 20.09 | 19.26 |
| | | 0.850 | 0.757 | 0.672 | 0.613 | 0.732 | 0.643 | 0.569 | 0.521 | 0.756 | 0.621 | 0.536 | 0.486 |
| Restormer | | 26.98 | 26.59 | 26.26 | 25.32 | 24.59 | 24.26 | 23.99 | 23.37 | 21.82 | 21.43 | 21.06 | 20.70 |
| | | 0.749 | 0.738 | 0.722 | 0.689 | 0.658 | 0.640 | 0.624 | 0.591 | 0.628 | 0.605 | 0.582 | 0.557 |
| SwinIR | | 30.14 | 26.63 | 24.15 | 22.45 | 26.94 | 24.39 | 22.50 | 22.83 | 24.90 | 22.69 | 20.64 | 20.15 |
| | | 0.855 | 0.763 | 0.677 | 0.594 | 0.726 | 0.638 | 0.549 | 0.533 | 0.725 | 0.608 | 0.513 | 0.450 |
| Swin- | | 32.18 | 31.17 | 30.10 | 29.49 | 27.55 | 26.97 | 26.19 | 25.27 | 26.21 | 25.54 | 25.08 | 24.08 |
| Transformer | | 0.868 | 0.863 | 0.839 | 0.819 | 0.744 | 0.743 | 0.703 | 0.656 | 0.723 | 0.725 | 0.715 | 0.665 |
| HASR | | | | | | | | | | | | | |
| (MoCo) | | | | | | | | | | | | | |

For the evaluation of the Real-Micron dataset, the HASR model was initialized by employing the pretrained Degradation Information Extraction network obtained from the Real-Micron dataset, along with the pretrained HASR network acquired from the synthetic experiments. CNN based HASR was utilized in the evaluation due to the relatively small scale of the Real-Micron dataset.

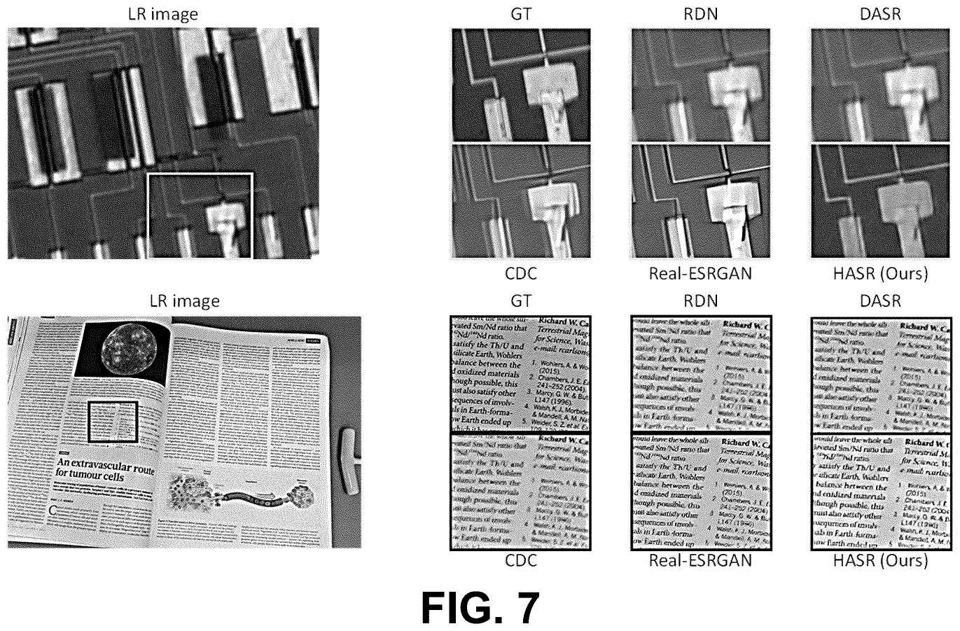

TABLE VI and TABLE VII shows the PSNR and SSIM results and confirms that our proposed HASR network achieved better quantitative evaluation results than other state-of-the-art algorithms. Additionally, FIG. 7 shows the SR visualization results on the Real-Micron and ImagePairs datasets, demonstrating that the proposed HASR network successfully reconstructs detailed textures and edges in the HR images, yielding better-looking SR outputs compared to other methods. While Real-ESRGAN produces sharper-looking details, it introduces some artifacts due to its adversarial model. The adversarial model prioritizes generating visually pleasing SR images over SR images closer to the input LR images, resulting in a tradeoff between the visual quality and the quantitative performance. Note the PSNR metric fundamentally disagrees with the subjective evaluation of human observers. If users care more about the quantitative performance in SR applications, e.g., using the HASR for product pattern inspection and metrology in manufacturing processes, the SR results must be as close as possible to the ground-truth rather than guessing a more visually pleasing image.

TABLE VI
PSNR and SSIM results on DRealSR and ImagePairs datasets.

| | | Canon | | Nikon | | Olympus | | Panasonic | | Sony | | LRC |
|---|---|---|---|---|---|---|---|---|---|---|---|---|
| | | Scale | | | | | | | | | | |
| Method | | ×2 | ×4 | ×2 | ×4 | ×2 | ×4 | ×2 | ×4 | ×2 | ×4 | ×2 |
| RDN | Backbone: | 32.41 | 28.56 | 32.49 | 28.05 | 32.07 | 28.07 | 32.21 | 28.14 | 31.85 | 29.27 | 22.30 |
| | CNN | 0.893 | 0.834 | 0.885 | 0.804 | 0.872 | 0.771 | 0.865 | 0.788 | 0.845 | 0.821 | 0.694 |
| Real- | | 27.53 | 24.83 | 29.68 | 26.95 | 29.66 | 26.31 | 29.54 | 26.03 | 26.68 | 26.53 | 21.86 |
| ESRGAN | | 0.868 | 0.793 | 0.886 | 0.798 | 0.867 | 0.750 | 0.848 | 0.748 | 0.810 | 0.766 | 0.785 |
| DASR | | 30.87 | 27.91 | 31.71 | 27.99 | 30.52 | 27.73 | 31.08 | 28.05 | 28.14 | 28.52 | 21.86 |
| | | 0.898 | 0.844 | 0.901 | 0.831 | 0.881 | 0.796 | 0.873 | 0.806 | 0.831 | 0.826 | 0.735 |
| CDC | | 32.61 | 30.43 | 33.12 | 29.84 | 31.58 | 29.31 | 32.43 | 30.18 | 28.63 | 29.93 | 22.10 |
| | | 0.933 | 0.898 | 0.930 | 0.874 | 0.909 | 0.832 | 0.903 | 0.847 | 0.851 | 0.854 | 0.785 |
| CNN | | 34.10 | 30.78 | 34.18 | 29.73 | 33.63 | 29.77 | 33.70 | 30.92 | 31.61 | 31.50 | 25.26 |
| HASR | | 0.932 | 0.884 | 0.917 | 0.841 | 0.906 | 0.811 | 0.891 | 0.816 | 0.843 | 0.846 | 0.829 |
| (MoCo) | | | | | | | | | | | | |
| DiffBIR | Backbone: | 26.99 | 26.99 | 27.51 | 26.98 | 27.27 | 27.17 | 27.63 | 27.22 | 25.84 | 27.20 | 21.73 |
| | Transformer | 0.805 | 0.802 | 0.774 | 0.777 | 0.757 | 0.739 | 0.761 | 0.757 | 0.724 | 0.768 | 0.751 |
| HAT | | 30.27 | 27.75 | 31.50 | 27.43 | 31.67 | 27.47 | 33.46 | 28.40 | 31.79 | 29.12 | 21.87 |
| | | 0.874 | 0.822 | 0.892 | 0.810 | 0.886 | 0.778 | 0.885 | 0.789 | 0.875 | 0.818 | 0.756 |
| Restormer | | 30.25 | 28.62 | 30.11 | 28.46 | 29.82 | 28.22 | 30.16 | 28.57 | 28.67 | 28.83 | 22.37 |
| | | 0.895 | 0.855 | 0.874 | 0.827 | 0.862 | 0.796 | 0.862 | 0.806 | 0.787 | 0.818 | 0.759 |
| SwinIR | | 31.30 | 28.97 | 31.68 | 27.47 | 30.33 | 28.02 | 30.50 | 27.95 | 30.82 | 28.39 | 21.68 |
| | | 0.902 | 0.852 | 0.886 | 0.795 | 0.858 | 0.780 | 0.847 | 0.782 | 0.855 | 0.808 | 0.688 |
| Swin- | | 35.27 | 32.59 | 33.88 | 31.58 | 34.30 | 30.94 | 34.08 | 31.09 | 31.70 | 32.65 | 25.62 |
| Transformer | | 0.929 | 0.893 | 0.911 | 0.867 | 0.908 | 0.821 | 0.892 | 0.839 | 0.849 | 0.879 | 0.807 |
| HASR | | | | | | | | | | | | |
| (MoCo) | | | | | | | | | | | | |

TABLE VII
PSNR and SSIM results on Real-Micron dataset.

| | | Cameras | | |
|---|---|---|---|---|
| Method | Scale | C640 | C1300 | C4112 |
| RDN | ×2 | 22.06 | 22.01 | 15.01 |
| | | 0.854 | 0.846 | 0.761 |
| DASR | | 21.98 | 11.96 | 12.02 |
| | | 0.854 | 0.560 | 0.740 |
| CDC | | 21.83 | 21.50 | 12.13 |
| | | 0.862 | 0.867 | 0.761 |
| CNN | | 28.99 | 28.07 | 21.02 |
| HASR | | 0.921 | 0.900 | 0.841 |
| (MoCo) | | | | |
| RDN | ×4 | 19.90 | 17.18 | 11.05 |
| | | 0.839 | 0.823 | 0.725 |
| DASR | | 19.89 | 17.17 | 11.02 |
| | | 0.845 | 0.830 | 0.727 |
| CDC | | 19.57 | 17.15 | 11.11 |
| | | 0.836 | 0.825 | 0.726 |
| CNN | | 27.79 | 25.02 | 21.54 |
| HASR | | 0.904 | 0.914 | 0.869 |
| (MoCo) | | | | |

### E. Ablation Studies

The effectiveness of the degradation information in the network was first evaluated by conducting ablation experiments using three different backbones. Then, the effectiveness of the dual-path attention mechanism was evaluated by conducting an ablation experiment using different fusion methods. Finally, the performance of transfer learning on Real-Micron dataset was evaluated by training and evaluating various models.

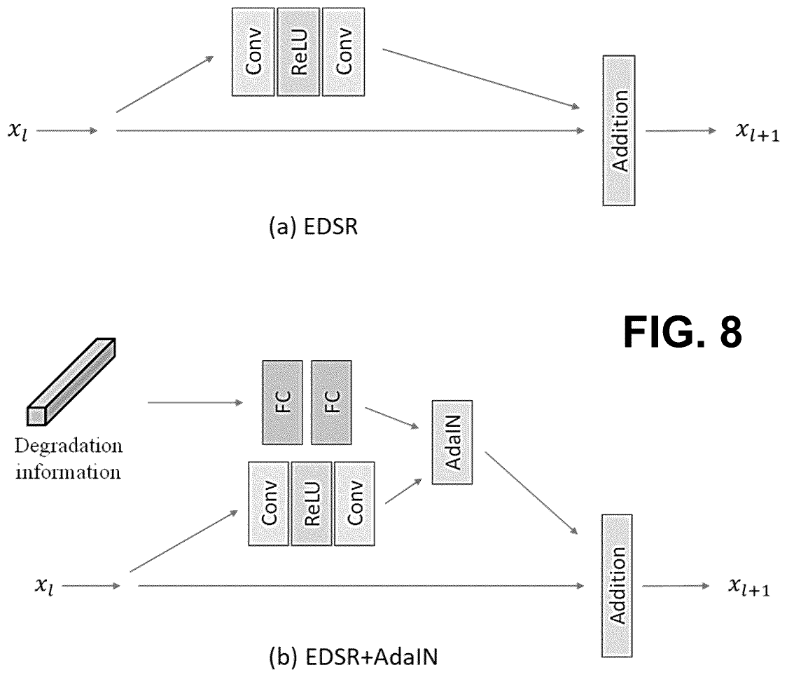

1) Analysis on Degradation Information: The backbones we have implemented include CNN based HASR, Restormer based HASR, and EDSR with Adaptive Instance Normalization (AdaIN). To disregard the degradation information, set λ=0 for [symbol] of the HASR networks and compared the experiment results of these models to the results of previous HASR networks for the first two comparisons. To explore the generalizability of the degradation information, an experiment was conducted on another SR backbone with a different fusion method, EDSR with AdaIN fusion method. For this experiment, specific modifications were made to the residual blocks of EDSR. Specifically, the two-FC-layer projected degradation information was used as the style feature map for AdaIN, while the feature map from the original residual blocks served as the content feature map. These two feature maps were then combined using an AdaIN layer. FIG. 8 illustrates both the original and modified residual blocks. Similarly, two models were trained for this architecture with λ=0.1 and λ=0, respectively.

TABLE IX displays the PSNR and SSIM results for these three models (HASR^{CNN}, HASR^{RT}, EDSR respectively represent CNN HASR, Restormer HASR, and EDSR backbones). It is evident that the inclusion of degradation information enhances the performance of both SR networks, confirming the effectiveness of this approach.

TABLE VIII
PSNR and SSIM results of different fusion methods.

| | | Kernel width (σ) | | | | | | | | | | | |
|---|---|---|---|---|---|---|---|---|---|---|---|---|---|
| | | 1.0 | 2.0 | 3.0 | 4.0 | 1.0 | 2.0 | 3.0 | 4.0 | 1.0 | 2.0 | 3.0 | 4.0 |
| Method | scale | Set5 | | | | Set14 | | | | Urban100 | | | |
| SA | ×4 | 29.87 | 29.66 | 28.39 | 28.05 | 26.41 | 26.11 | 25.71 | 24.54 | 23.53 | 23.94 | 22.95 | 22.81 |
| only | | 0.829 | 0.825 | 0.783 | 0.779 | 0.722 | 0.694 | 0.677 | 0.625 | 0.668 | 0.662 | 0.632 | 0.609 |
| CA | | 29.29 | 29.41 | 29.01 | 28.63 | 26.32 | 25.78 | 24.76 | 24.18 | 24.10 | 24.08 | 23.33 | 22.67 |
| only | | 0.803 | 0.810 | 0.794 | 0.764 | 0.714 | 0.702 | 0.663 | 0.634 | 0.687 | 0.667 | 0.645 | 0.617 |
| CA | | 29.33 | 28.59 | 28.44 | 27.71 | 25.79 | 25.08 | 25.33 | 24.16 | 23.38 | 23.26 | 22.40 | 21.89 |
| outside | | 0.812 | 0.790 | 0.796 | 0.760 | 0.700 | 0.682 | 0.641 | 0.609 | 0.660 | 0.651 | 0.617 | 0.574 |
| of | | | | | | | | | | | | | |
| RCAB | | | | | | | | | | | | | |
| CNN | | 30.66 | 30.05 | 29.83 | 29.73 | 26.99 | 26.55 | 26.25 | 25.45 | 25.36 | 24.95 | 24.33 | 23.64 |
| HASR | | 0.847 | 0.826 | 0.819 | 0.803 | 0.749 | 0.726 | 0.706 | 0.653 | 0.735 | 0.709 | 0.704 | 0.657 |
| (MoCo) | | | | | | | | | | | | | |

TABLE IX
PSNR and SSIM comparisons with/without degradation information.

| Method | Scale | Canon | Nikon | Olympus | Panasonic | Sony |
|---|---|---|---|---|---|---|
| ${HASR}_{λ = 0}^{CNN}$ | × 4 | 30.51 0.874 | 29.79 0.830 | 29.68 0.805 | 30.77 0.819 | 30.30 0.839 |
| ${HASR}_{λ = 0.}^{CNN}$ | | 30.78 0.884 | 29.73 0.841 | 29.77 0.811 | 30.92 0.816 | 31.50 0.846 |
| ${HASR}_{λ = 0}^{RT}$ | | 28.62 0.855 | 28.46 0.827 | 28.22 0.796 | 28.57 0.806 | 28.83 0.818 |
| ${HASR}_{λ = 0.}^{RT}$ | | 30.50 0.896 | 29.56 0.851 | 30.00 0.807 | 29.31 0.821 | 30.46 0.834 |
| EDSR_{λ=0} | | 30.32 | 29.32 | 29.46 | 29.74 | 29.63 |
| | | 0.870 | 0.829 | 0.790 | 0.816 | 0.820 |
| EDSR_{λ=0.} | | 31.69 | 29.55 | 29.73 | 30.28 | 30.09 |
| | | 0.883 | 0.836 | 0.793 | 0.814 | 0.831 |

2) Analysis on Feature Fusion: To evaluate the effectiveness of the dual-path attention mechanisms, experiments were conducted of different fusion approaches of the CNN based HASR network. Specifically, the original HASR was compared with single path attention (either only spatial or channel attention) and channel attention outside of RCAB. TABLE VIII shows the PSNR and SSIM comparison of different fusion methods.

The method which performed the worst was the one where fusion occurred outside of the RCAB. This outcome may be attributed to the absence of degradation information during the deep feature extraction process, which occurred inside RCAB. Similarly, methods employing a single path, be it the CA or SA path, exhibited worse performance. These single-path methods lack connections between adjacent pixels or feature channels, making them less effective compared to the proposed fusion method with dual-path.

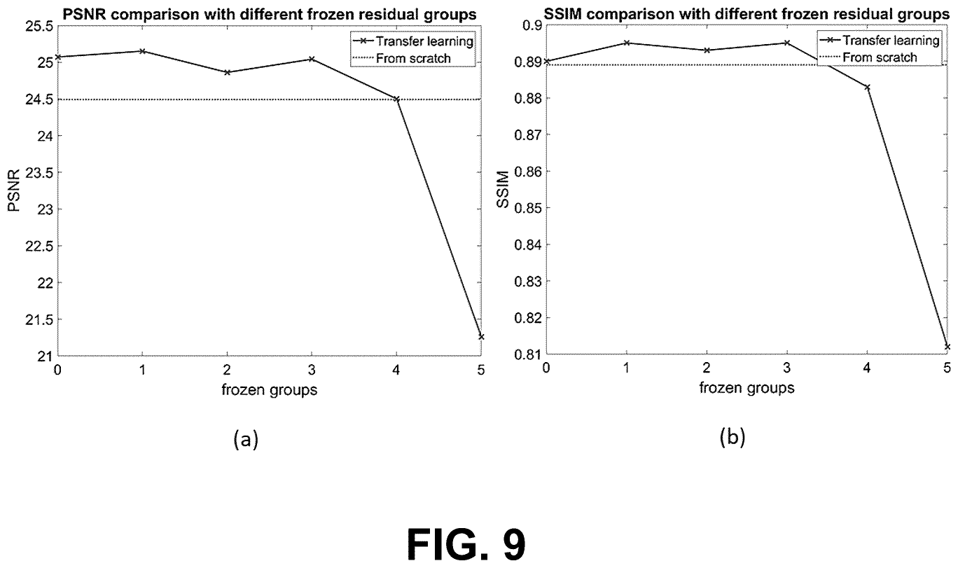

3) Analysis on Transfer Learning: To evaluate the effectiveness of transfer learning on the Real-Micron dataset, two sets of experiments were conducted using the CNN based HASR network. First, the HASR network was trained using only the Real-Micron training data, with the degradation information part pretrained and the HASR part randomly initialized. Second, the network was trained using the same training data with both pretrained degradation information and HASR parts. For the latter, different residual groups were frozen in the models during training. FIG. 9 shows the PSNR and SSIM results of both transfer learning metrics.

The results indicate that transfer learning outperforms direct training from scratch when the weights of the first one, two or three residual groups are frozen. This is reasonable due to two factors. First, the Real-Micron dataset has fewer LR-HR image pairs than other public datasets like ImagePairs and DRealSR, making overfitting a potential issue during training from scratch. Second, by using the pretrained model (DIV2K+Flirck2K) to initialize the HASR, the SR performance can be improved. However, since the pretrained model has domain gaps with the Real-Micron dataset, the best performance was achieved when unlocking the weights of the last and penultimate residual groups. This approach locks in the learned generic features from pretrained model, while providing enough learnable parameters for learning the unique features of the Real-Micron dataset.

### Supplemental Materials for Hardware Aware Network for Real-World Single Image Super-Resolution

### A. Deep Feature Extraction Module (DFEM)

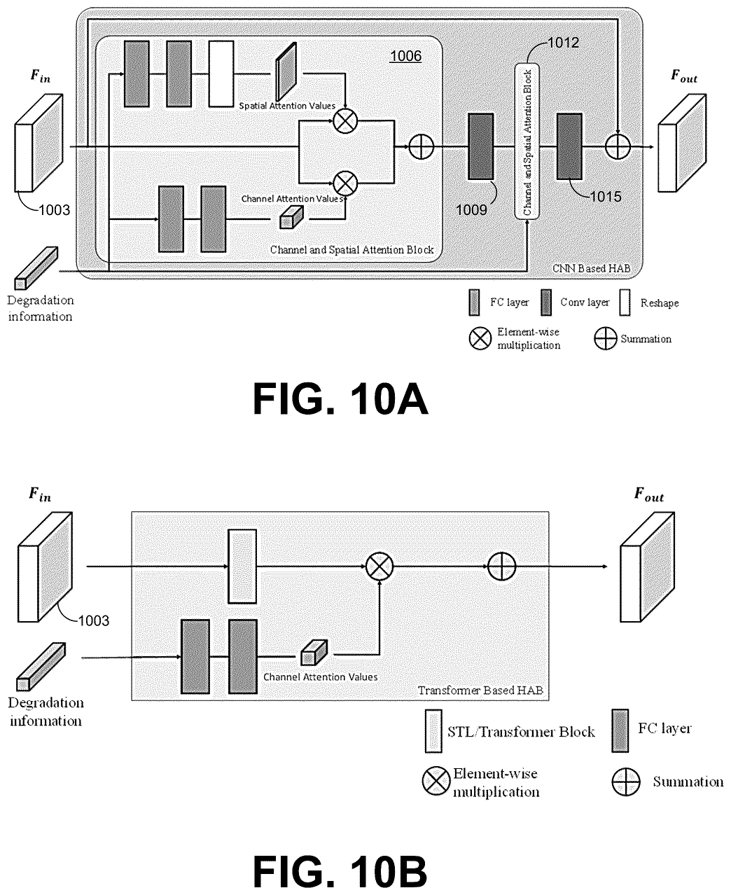

The DFEM can be implemented using either a convolutional neural network (CNN) based or a Transformer based feature extraction approach. A comprehensive breakdown of both these approaches is provided in FIGS. 10A and 10B. In FIG. 10A, the CNN-based HAB involves several steps. Initially, it multiplies the input feature map 1003 by spatial and channel attention values and combines them by summation. These steps are encapsulated within the Channel and Spatial Attention Block (CSAB) 1006. Following this, a convolution layer 1009 is applied to the output from the CSAB 1006. Subsequently, a second CSAB 1012 and another convolution layer 1015 are sequentially utilized. Finally, a skip connection is introduced to enable the summation of the input feature map 1003 with the final output feature map. In FIG. 10B, the transformer-based HAB primarily relies on channel attention values, as spatial attention did not demonstrate substantial improvements for this specific application. To streamline the network parameters, only the channel attention path is employed. In this example, the Swin-Transformer Layer (STL) (SwinIR) and Transformer Block (Restormer) was adopted for the deep feature extraction. The Swin-Transformer performs the best because it amalgamates the strengths of both CNN and Transformer models, proving effective for dense prediction tasks. We also included the Restormer based HASR results in TABLE X and TABLE XI. The results also indicated that the inclusion of HABs consistently enhances the quality of SR results.

TABLE X
PSNR and SSIM results: Fine-tuned Restormer versus Restormer based HASR.

| | | Kernel width (σ) | | | | | | | | | | | |
|---|---|---|---|---|---|---|---|---|---|---|---|---|---|
| | | 1.0 | 2.0 | 3.0 | 4.0 | 1.0 | 2.0 | 3.0 | 4.0 | 1.0 | 2.0 | 3.0 | 4.0 |
| Method | scale | Set5 | | | | Set14 | | | | Urban100 | | | |
| Restormer | ×2 | 31.45 | 29.57 | 27.50 | 25.84 | 28.75 | 26.87 | 24.88 | 23.57 | 25.45 | 23.49 | 21.66 | 20.56 |
| | | 0.891 | 0.843 | 0.777 | 0.717 | 0.838 | 0.766 | 0.672 | 0.608 | 0.825 | 0.735 | 0.620 | 0.544 |
| Restormer | | 35.20 | 32.79 | 30.38 | 28.81 | 31.03 | 29.11 | 26.94 | 25.97 | 28.57 | 26.45 | 24.02 | 22.83 |
| based | | 0.931 | 0.895 | 0.851 | 0.811 | 0.879 | 0.825 | 0.739 | 0.698 | 0.902 | 0.845 | 0.753 | 0.692 |
| HASR | | | | | | | | | | | | | |
| Restormer | ×4 | 26.98 | 26.59 | 26.26 | 25.32 | 24.59 | 24.26 | 23.99 | 23.37 | 21.82 | 21.43 | 21.06 | 20.70 |
| | | 0.749 | 0.738 | 0.722 | 0.689 | 0.658 | 0.640 | 0.624 | 0.591 | 0.628 | 0.605 | 0.582 | 0.557 |
| Restormer | | 29.74 | 29.63 | 28.96 | 27.55 | 26.40 | 26.33 | 25.92 | 24.91 | 23.81 | 23.76 | 23.35 | 22.56 |
| based | | 0.840 | 0.836 | 0.817 | 0.779 | 0.723 | 0.717 | 0.697 | 0.647 | 0.729 | 0.728 | 0.705 | 0.662 |
| HASR | | | | | | | | | | | | | |

TABLE XI
PSNR and SSIM results: Fine-tuned Restormer versus Restormer based HASR.

| | | DRealSR and ImagePairs | | | | | |
|---|---|---|---|---|---|---|---|
| Method | scale | Canon | Nikon | Olympus | Panasonic | Sony | LRC |
| Restormer | ×2 | 30.25 | 30.11 | 29.82 | 30.16 | 28.67 | 22.37 |
| | | 0.895 | 0.874 | 0.862 | 0.862 | 0.787 | 0.759 |
| Restormer | | 33.89 | 33.23 | 32.80 | 32.89 | 31.12 | 25.74 |
| based | | 0.938 | 0.910 | 0.903 | 0.893 | 0.856 | 0.830 |
| HASR | | | | | | | |
| | | DRealSR | | | | | |
| Restormer | ×4 | 28.62 | 28.46 | 28.22 | 28.57 | 28.83 | — |
| | | 0.855 | 0.827 | 0.796 | 0.806 | 0.818 | |
| Restormer | | 30.50 | 29.56 | 30.00 | 29.31 | 30.46 | — |
| based | | 0.896 | 0.851 | 0.807 | 0.821 | 0.834 | |
| HASR | | | | | | | |

### B. Real-Micron Dataset

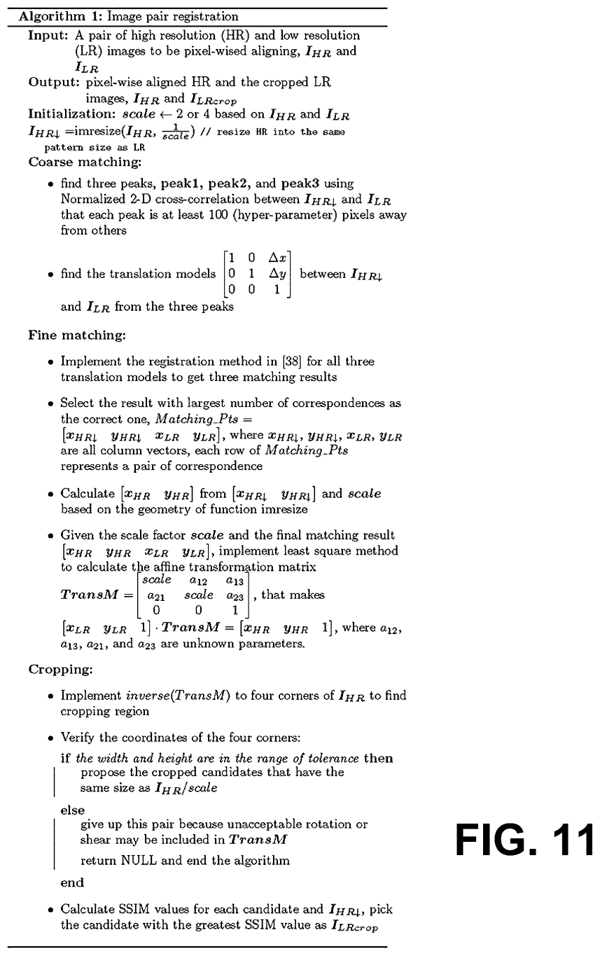

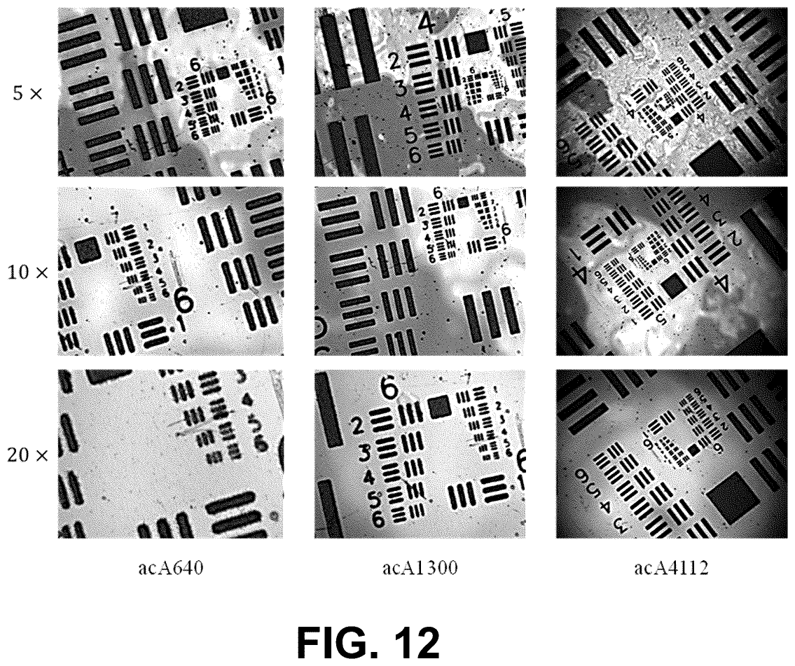

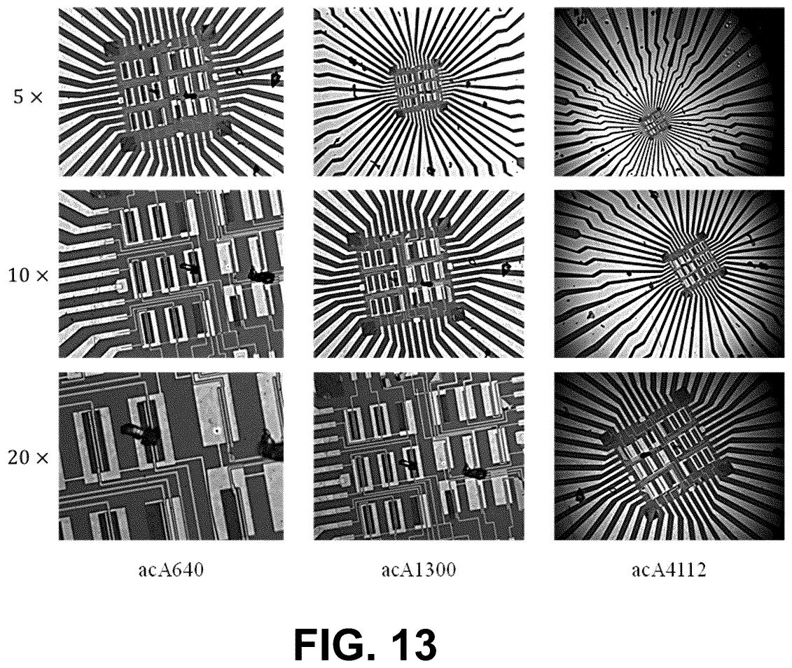

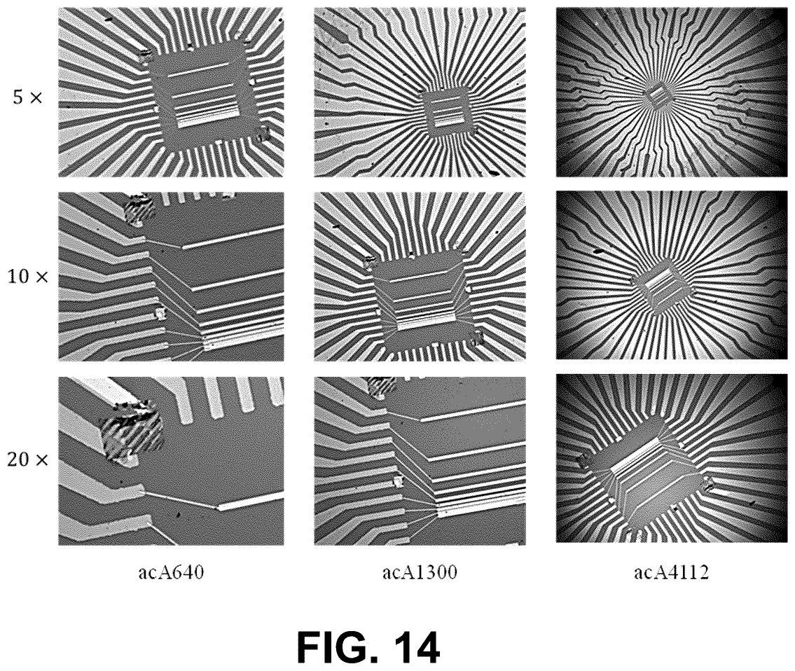

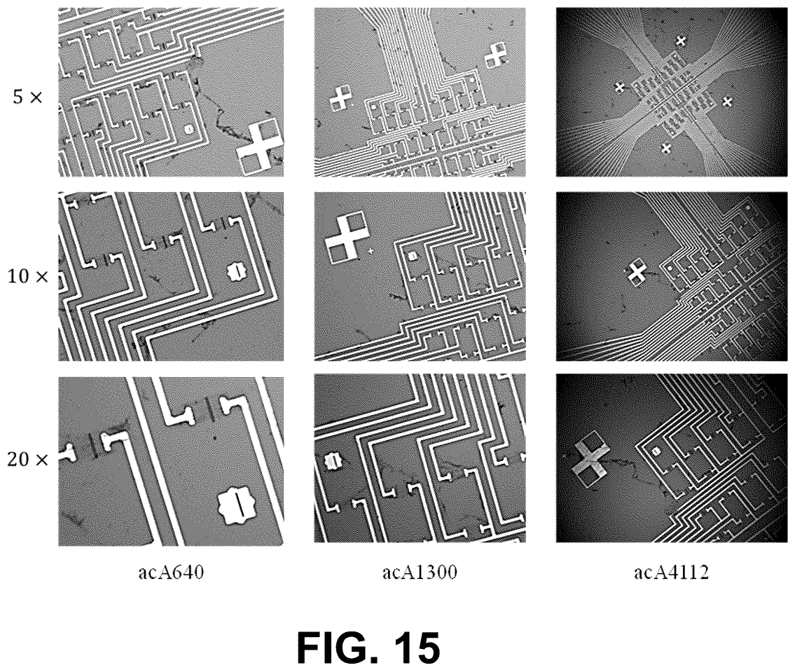

The step-by-step image pair registration algorithm is illustrated in FIG. 11. The proposed image pair registration algorithm involves a coarse-to-fine process that makes the accurate LR-HR pairs. As described, four different samples were captured by the acquisition system containing multiple cameras and objectives, including the US Air Force Hi-Resolution target and three different micro-scale circuits. FIG. 12 to FIG. 15 show the example images from the four samples. Specifically, each row of the images is captured by the same objective, each column of the images is captured by the same camera.

### C. Transfer Learning Details for Real-Micron Dataset

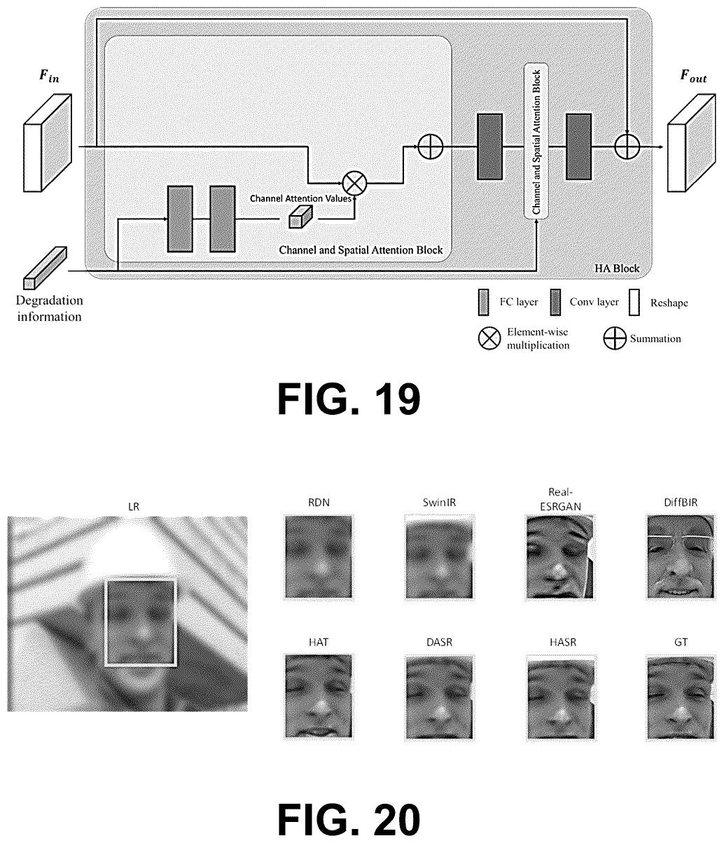

The Real-Micron dataset comprises a limited number of LR-HR image pairs-132 for ×2 and 397 for ×4 training, significantly fewer than the typical deep learning model's demand. To address this limitation, transfer learning was employed to enhance model performance. The Degradation Information Extraction network employs a 6-layer CNNs backbone, MoCo-V2 as the training algorithm, SuperCon loss function. For the Real-Micron dataset, this network was trained using the LR images and camera labels for 1000 iterations, saving it as the pretrained Degradation Information Extraction model. Then, as shown in FIG. 19, we have trained the whole CNN HASR using DIV2K and Flickr2K synthetic datasets, saving it as the synthetic pretrained model. To initiate transfer learning, the complete CNN HASR was initialized with the synthetic pretrained model. Then, the degradation information part was overwritten by the pretrained Degradation Information Extraction model. The learning rate of the SR part was set to 1×10⁻⁴, while the learning rate of the degradation information part (6-layer CNNs) was set to 1×10⁻⁹. In the ablation study, the approach to freezing weights at different residual groups, as illustrated in FIG. 19. The grey boxes represent the residual groups, totaling five in the model. In the first experiment, we did not freeze any weights, training the model for 20K iterations. In the second experiment, we froze the weights before the end of the first residual group, training the model for 20K iterations. Subsequently, we progressively locked the weights of more residual groups, leading to different experiments. As a baseline, the entire model was trained from scratch using only the pretrained Degradation Information Extraction model. For this baseline, the learning rates were set as before, but the model was trained for 200K iterations. The PSNR and SSIM results are presented in FIG. 9.

The results indicate that transfer learning outperforms direct training from scratch when the weights of the first one, two or three residual groups are frozen. This is reasonable due to two factors. First, the Real-Micron dataset has fewer LR-HR image pairs than other public datasets like ImagePairs and DRealSR, making overfitting a potential issue during training from scratch. Second, by using the pretrained model (DIV2K+Flirck2K) to initialize the HASR, the SR performance can be improved. However, since the pretrained model has domain gaps with the Real-Micron dataset, the best performance was achieved when unlocking the weights of the last and penultimate residual groups. This approach locks in the learned generic features from pretrained model, while providing enough learnable parameters for learning the unique features of the Real-Micron dataset.

### D. Feature Fusion Methods

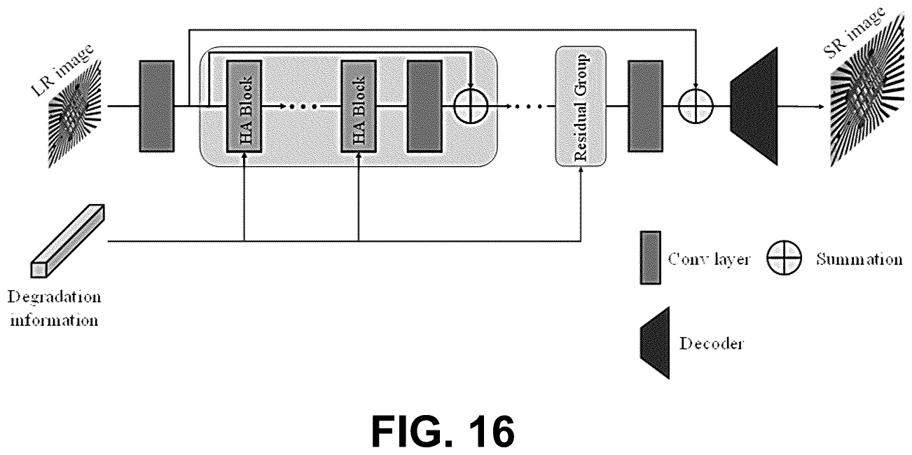

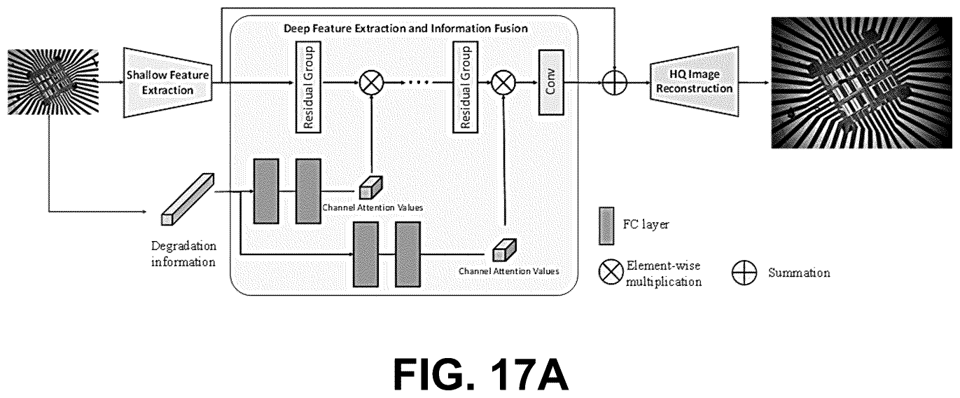

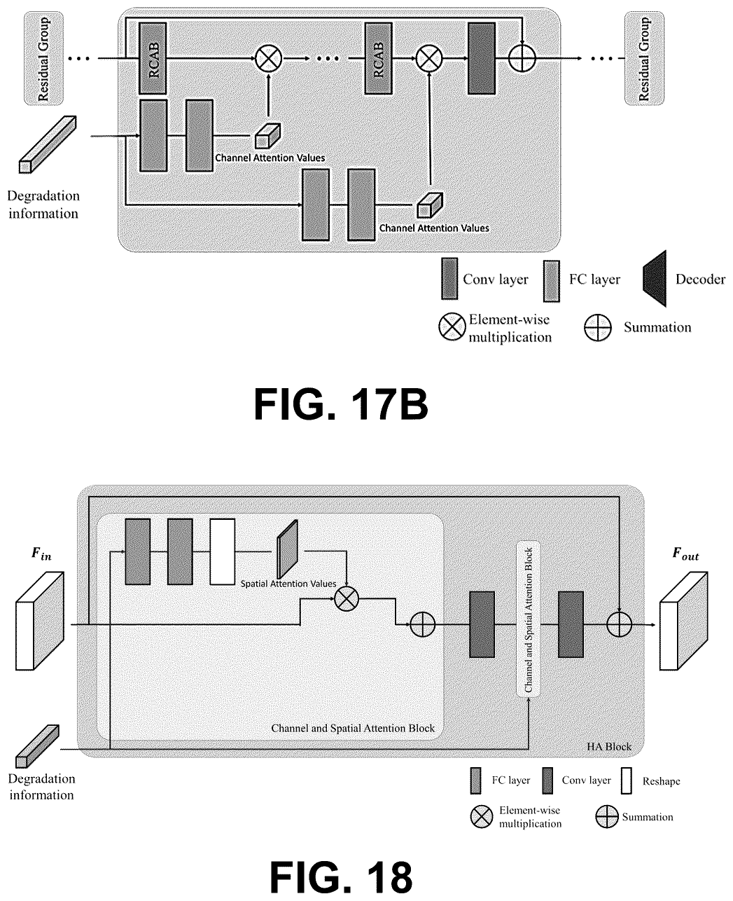

Multiple fusion methods were explored in the experiments. This section will present all the details of each method. FIG. 16 shows different fusion architectures of both Transformer based CNN based networks. Specifically, it highlights the key differences in fusion placement between the proposed HASR and the architectures in FIGS. 17A and 17B. In FIG. 17A, for the transformer based HASR, the fusion occurs after each residual group while the proposed approach incorporates fusion within the residual groups. Similarly, for the proposed CNN based HASR, the dual-path attention mechanism operates inside the Residual Channel Attention Block (RCAB), while FIG. 17B shows the mechanism operating outside the RCAB.

The selection of these fusion methods was driven by the objective to evaluate the effectiveness of deep fusion. In these two methods, the degradation information interacts with the LR feature map to a lesser extent compared to the proposed approaches. TABLE IX provides a clear performance comparison, demonstrating that the proposed architecture consistently achieves superior results across most test datasets. It's worth noting that TABLE VIII already highlighted the suboptimal performance of FIG. 17B among the four fusion methods. In addition, FIG. 18 and FIG. 19 present the detailed explanation of fusion methods with single path attention mechanism in the ablation study. This section serves to provide a comprehensive understanding of the feature fusion methods employed in our experiments and their impact on super-resolution performance.

TABLE XII
PSNR and SSIM results of different fusion methods.

| | | Kernel width (σ) | | | | | | | | | | | |
|---|---|---|---|---|---|---|---|---|---|---|---|---|---|
| | | 1.0 | 2.0 | 3.0 | 4.0 | 1.0 | 2.0 | 3.0 | 4.0 | 1.0 | 2.0 | 3.0 | 4.0 |
| Method | scale | Set5 | | | | Set14 | | | | Urban100 | | | |
| Swin- | ×4 | 31.31 | 31.29 | 30.78 | 29.49 | 26.34 | 26.60 | 26.63 | 25.66 | 24.76 | 24.94 | 24.66 | 23.46 |
| Transformer | | 0.857 | 0.861 | 0.839 | 0.818 | 0.712 | 0.723 | 0.704 | 0.675 | 0.725 | 0.719 | 0.699 | 0.650 |
| HASR CA | | | | | | | | | | | | | |
| w/ RG | | | | | | | | | | | | | |
| Swin- | | 32.18 | 31.17 | 30.10 | 29.49 | 27.55 | 26.97 | 26.19 | 25.27 | 26.21 | 25.54 | 25.08 | 24.08 |
| Transformer | | 0.868 | 0.863 | 0.839 | 0.819 | 0.744 | 0.743 | 0.703 | 0.656 | 0.723 | 0.725 | 0.715 | 0.665 |
| HASR w/ | | | | | | | | | | | | | |
| STL | | | | | | | | | | | | | |

### E. More Visualization Results

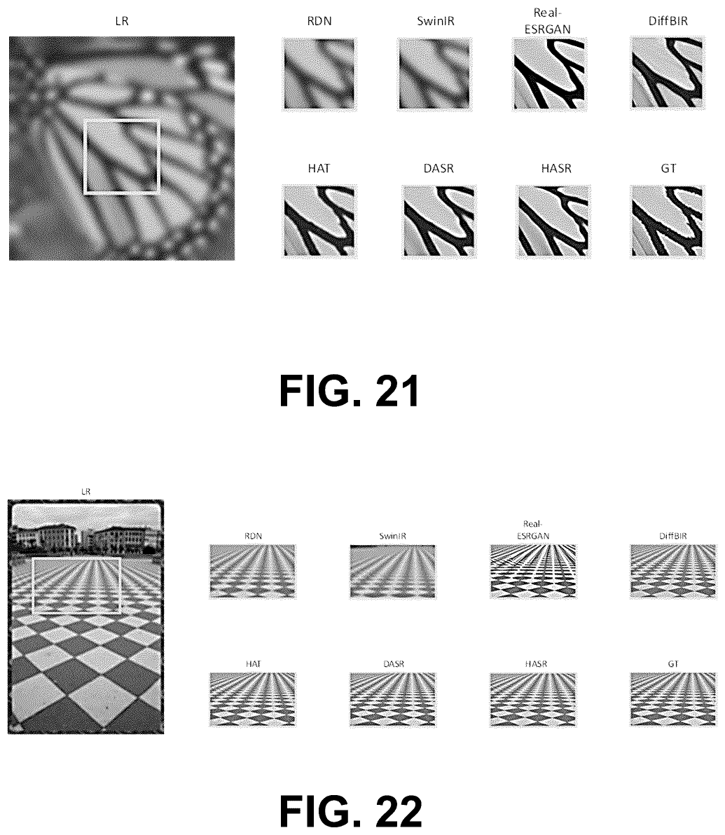

This section provides more visualization SR results. From FIG. 20 to FIG. 22, it can be observed that HASR achieved better results than other SISR methods when the LR images are heavily blurred by a greater σ value. An interesting result from FIG. 20 is that the DiffBIR algorithm generates extra features which do not exist in the groundtruth. The reason is the diffusion models prioritize generating visually pleasing SR images over SR images closer to the input LR images. If users care more about the quantitative performance in SR applications, e.g., using the HASR for product pattern inspection and metrology in manufacturing processes, the SR results must be as close as possible to the ground-truth rather than guessing a more visually pleasing image.

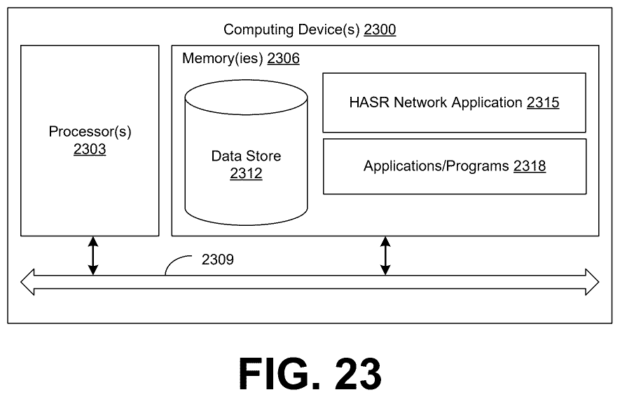

With reference next to FIG. 23, shown is a schematic block diagram of a computing device 2300. In some embodiments, among others, the computing device 2300 may represent one or more computing devices (e.g. a smartphone, tablet, computer, etc.). Each computing device 2300 includes at least one processor circuit, for example, having a processor 2303 and a memory 2306, both of which are coupled to a local interface 2309. To this end, each computing device 2300 may comprise, for example, at least one server computer or like device, which can be utilized in a cloud-based environment. The local interface 2309 may comprise, for example, a data bus with an accompanying address/control bus or other bus structure as can be appreciated. The local interface 2309 can facilitate communication with one or more imaging device (e.g., camera, etc.) that is used to capture images for processing.

In some embodiments, the computing device 2300 can include one or more network interfaces. The network interface may comprise, for example, a wireless transmitter, a wireless transceiver, and/or a wireless receiver (e.g., Bluetooth®, Wi-Fi, Ethernet, etc.). The network interface can communicate with a remote computing device using an appropriate communications protocol. As one skilled in the art can appreciate, other wireless protocols may be used in the various embodiments of the present disclosure.

Stored in the memory 2306 are both data and several components that are executable by the processor 2303. In particular, stored in the memory 2306 and executable by the processor 2303 are at least one HASR network application 2315 and potentially other applications and/or programs 2318. Also stored in the memory 2306 may be a data store 2312 and other data. In addition, an operating system may be stored in the memory 2306 and executable by the processor 2303.

It is understood that there may be other applications that are stored in the memory 2306 and are executable by the processor 2303 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 2306 and are executable by the processor 2303. In this respect, the term “executable” means a program or application file that is in a form that can ultimately be run by the processor 2303. Examples of executable programs may be, for example, a compiled program that can be translated into machine code in a format that can be loaded into a random access portion of the memory 2306 and run by the processor 2303, source code that may be expressed in proper format such as object code that is capable of being loaded into a random access portion of the memory 2306 and executed by the processor 2303, or source code that may be interpreted by another executable program to generate instructions in a random access portion of the memory 2306 to be executed by the processor 2303, etc. An executable program may be stored in any portion or component of the memory 2306 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 2306 is defined herein as including both volatile and nonvolatile memory and data storage components. Volatile components are those that do not retain data values upon loss of power. Nonvolatile components are those that retain data upon a loss of power. Thus, the memory 2306 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 2303 may represent multiple processors 2303 and/or multiple processor cores and the memory 2306 may represent multiple memories 2306 that operate in parallel processing circuits, respectively, such as multicore systems, FPGAs, GPUs, GPGPUs, spatially distributed computing systems (e.g., connected via the cloud and/or Internet). In such a case, the local interface 2309 may be an appropriate network that facilitates communication between any two of the multiple processors 2303, between any processor 2303 and any of the memories 2306, or between any two of the memories 2306, etc. The local interface 2309 may comprise additional systems designed to coordinate this communication, including, for example, performing load balancing. The processor 2303 may be of electrical or of some other available construction.

Although the HASR network application 2315 and other applications/programs 2318, described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the HASR network application 2315 and other applications/programs 2318, that comprises software or code can be embodied in any non-transitory computer-readable medium for use by or in connection with an instruction execution system such as, for example, a processor 2303 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the HASR network application 2315 and other applications/programs 2318, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 2300, or in multiple computing devices in the same computing environment. Additionally, it is understood that terms such as “application,” “service,” “system,” “engine,” “module,” and so on may be interchangeable and are not intended to be limiting.

In this disclosure, a blind SR method has been proposed that can handle various degradation processes of different image acquisition systems by extracting and integrating the prior hardware information. By the inclusion of HAB, both Transformer based and CNN based HASR networks outperform conventional approaches by not relying on predefined or ground-truth degradation kernels. Results from both synthetic and real-world datasets demonstrate the effectiveness of the proposed method in handling blind SR problems. The methodology can be extended to more state-of-the-art SR frameworks such as CDC and the effectiveness of the degradation information may be verified in these frameworks. Additionally, hardware knowledge may be utilized to effectively enhance image quality.

The HASR method can have significant impact on various areas, such as enhancing the accurate inspection of manufactured products for quality control and enhancing the resolution of medical images to enable more accurate diagnosis and healthcare. Current SR solutions neglect the uniqueness of each imaging system, hence cannot produce accurate HR images across the different systems. Taking advantage of the known hardware information, HASR can differentiate low-resolution images across different imaging systems and produce HR images that are closer to the real-world scenario. Given sufficient training images, the HASR method can overcome the physical optical limitation and generate higher quality images. The method can improve the overall performance by about 0.2 dB and 0.5 dB on the synthetic and the real-world datasets, respectively.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method of enhancing the resolution of an image, comprising:
extracting a hardware representation of an imaging system; and
integrating the hardware representation into a super-resolution network.

2. The method of claim 1, wherein extracting the hardware representation comprises:
providing a set of images from a plurality of imaging systems, the set of images comprising imaging system hardware information; and
training a contrasting learning system with the set of images to determine a degradation representation.

3. The method of claim 2, wherein the set of images comprises:
positive examples of each of the plurality of imaging systems; and
negative examples of each of the plurality of the imaging systems.

4. The method of claim 2, further comprising:
extracting degradation information from the low-resolution image with the contrasting learning system;
extracting a shallow feature map from the low-resolution image;
combining the degradation information and shallow feature map to form a dense feature map; and
creating a super-resolution image from the low-resolution image using the dense feature map.

5. The method of claim 4, wherein creating the super-resolution image from the low-resolution image using the dense feature map comprises optimization of loss functions represented by:
$$HASR ( {f}_{LR} ) = {arg min}_{HASR , {F}_{D}} \{ {ℒ}_{1} ( {f}_{SR} , {f}_{HR} ) + {λℒ}_{sup} ( {F}_{D} ( {f}_{LR} ) ) \} .$$

6. The method of claim 4, wherein combining the degradation information and shallow feature map comprises deep feature fusion as expressed by:
$${F}_{i} = {H}_{ResG}^{i} ( {F}_{i - 1} , h ) .$$

7. The method of claim 2, wherein training the contrasting learning system comprises use of a supervised contrastive loss given by:
$${L}_{sup} = {\sum }_{i ∈ I} {L}_{sup , i} = {\sum }_{i ∈ I} \frac{- 1}{\vert P ( i ) \vert} {\sum }_{p ∈ P ( i )} log \frac{exp ( {z}_{i} \cdot {z}_{p} / τ )}{{\sum }_{a ∈ A ( i )} exp ( {z}_{i} \cdot {z}_{a} / τ )} .$$

8. The method of claim 2, wherein the degradation representation comprises:
$$h = {F}_{D} ( {f}_{LR} )$$
wherein F_{D} is a degradation information extraction network applied to the low-resolution image f_{LR}.

9. A method of enhancing the resolution of an image, comprising:
extracting degradation information from a low-resolution image;
extracting a shallow feature map from the low-resolution image;
combining the degradation information and shallow feature map to form a dense feature map; and
creating a super-resolution image from the low-resolution image using the dense feature map.

10. The method of claim 9, wherein the step of extracting a hardware representation comprises:
providing a set of images from a plurality of imaging systems, the set of images comprising imaging system hardware information; and
training a contrasting learning system with the set of images to determine a degradation feature map.

11. The method of claim 10, wherein the set of images comprises:
positive examples of each of the plurality of imaging systems; and
negative examples of each of the plurality of the imaging systems.

12. The method of claim 9, wherein creating the super-resolution image from the low-resolution image using the dense feature map comprises optimization of loss functions represented by:
$$HASR ( {f}_{LR} ) = {arg min}_{HASR , {F}_{D}} \{ {ℒ}_{1} ( {f}_{SR} , {f}_{HR} ) + {λℒ}_{sup} ( {F}_{D} ( {f}_{LR} ) ) \} .$$

13. The method of claim 9, wherein combining the degradation information and shallow feature map comprises deep feature fusion as expressed by:
$${F}_{i} = {H}_{ResG}^{i} ( {F}_{i - 1} , h ) .$$

14. The method of claim 9, wherein the degradation representation comprises:
$$h = {F}_{D} ( {f}_{LR} )$$
wherein F_{D} is a degradation information extraction network applied to the low-resolution image f_{LR}.

15. A system for enhancing the resolution of an image, comprising:
a computing system comprising processing circuitry including a processor and memory;
a contrast learning system executable by the computing system, the contrast learning system trained with a set of images from a plurality of imaging systems, the set of images comprising imaging system hardware information, the trained contrast learning system having a degradation representation determined from the set of images, the trained contrast learning system configured to, when executed by the computing system, at least extract degradation information from a low-resolution image; and
a super-resolution imaging system executable by the computing system, the super-resolution imaging system configured to, when executed by the computing system, at least:
extract a shallow feature map from the low-resolution image;
combine the degradation information and shallow feature map to form a dense feature representation; and
create a super-resolution image from the low-resolution image using the dense feature representation.

16. The system of claim 15, wherein the set of images, comprises:
positive examples of each of the plurality of imaging systems; and
negative examples of each of the plurality of the imaging systems.

17. The system of claim 15, wherein creating the super-resolution image from the low-resolution image using the dense feature map comprises optimization of loss functions represented by:
$$HASR ( {f}_{LR} ) = {arg min}_{HASR , {F}_{D}} \{ {ℒ}_{1} ( {f}_{SR} , {f}_{HR} ) + {λℒ}_{sup} ( {F}_{D} ( {f}_{LR} ) ) \} .$$

18. The system of claim 15, wherein combining the degradation information and shallow feature map comprises deep feature fusion as expressed by:
$${F}_{i} = {H}_{ResG}^{i} ( {F}_{i - 1} , h ) .$$

19. The system of claim 15, wherein the degradation representation comprises:
$$h = {F}_{D} ( {f}_{LR} )$$
wherein F_{D} is a degradation information extraction network applied to the low-resolution image f_{LR}.
